(19) United States
(12) Patent Application Publication
(10) Pub. No.: US 2003/0067627 A1
(43) Pub. Date: Apr. 10, 2003

(54) Image processing method and its data cache method

(76) Inventors: Tomoe Ishikawa, Tokyo (JP); Miyuki Enokida, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/231,206

(22) Filed: Aug. 30, 2002

(30) Foreign Application Priority Data
Aug. 30, 2001 (JP) 261799/2001(PAT.)
Nov. 29, 2001 (JP) 364894/2001(PAT.)
Jul. 30, 2002 (JP) 222021/2002(PAT.)

(51) Int. Cl. G06F 5/00; G06F 15/00

(52) U.S. Cl. 358/1.15; 709/246; 709/247

(57) ABSTRACT

Header data associated with an image is received from an external apparatus prior to reception of encoded data, the number of tiles which form the image, and the number of encoded data required to form each tile are calculated on the basis of the received header data, predetermined dummy encoded data (ZLP) are set in correspondence with the number of encoded data in each of the calculated tiles, and the dummy encoded data, corresponding to the encoded data actually received from the external apparatus, of the set dummy encoded data are replaced by the encoded data received from the external apparatus.

### FIELD OF THE INVENTION

The present invention relates to an image processing apparatus for exchanging and processing encoded image data, and its data cache method.

### BACKGROUND OF THE INVENTION

On the Internet, users actively access WWW servers from Web browsers to browse document data, image data, and the like. This mechanism includes WWW servers used to disclose information on the Internet, and clients used to browse such information, and each client can browse information disclosed by the servers. Each WWW server stores a document which is called a home page, and describes information to be disclosed in HTML, and the Web browser on the client side accesses such home page to display it on the client computer. The Web browser on the client side can get required information by tracing links in displayed pages. Furthermore, as a method of downloading files managed by each server, a File Transfer Protocol (to be abbreviated as FTP hereinafter) is known. The FTP is a mechanism for transferring a file on the server to the client computer at once.

As a protocol for fragmentarily accessing and displaying an image file, Flashpix/IIP is known. This IIP is a protocol optimal to the format “Flashpix” of an image data file, and partial access to image data is made for respective tiles specified by this Flashpix.

The user of an image processing apparatus such as a personal computer (to be simply referred to as a computer hereinafter) or the like that can establish connection to the Internet accesses WWW (World Wide Web) servers on the Internet using the functions of a Web browser of that apparatus so as to browse various document data, image data and the like.

In recent years, a JPEG (Joint Photographic Experts Group) 2000 image encoding technique complying with ISO/IEC-15444 has been proposed. In a client/server environment built on a general communication network including the Internet, when Flashpix/IIP is directly applied to image data encoded based on JPEG2000 (to be referred to as encoded data hereinafter), encoded data of each scalability in JPEG2000 becomes difference data based on data of scalability one level lower than that scalability.

Therefore, Flashpix can decode image data of only a given tile, while a computer on the client side (user terminal) requires encoded data lower than the scalability of an image to be displayed currently upon decoding based on JPEG2000.

In consideration of such situation, various methods have been proposed as a method of extracting only required partial data from image encoded data having multi-resolution data, and converting the extracted data into another encoded data. For example, U.S. Pat. No. 6,041,143 (“MULTIRESOLUTION COMPRESSED IMAGE MANAGEMENT SYSTEM AND METHOD”) is known. In this patent, image data serving as a source is encoded data that manages multi-resolution data using wavelet transformation or wavelet-like transformation. Encoded data required to process data of a spatial region selected by the client is extracted from the source encoded data, and is converted into one, independent encoded data. At this time, partial encoded data extracted from the source encoded data corresponds to code-blocks of JPEG2000, and contains all encoded data corresponding to or associated with all layers or subbands required to process the current client request. However, U.S. Pat. No. 6,041,143 suffers the following problem.

When this U.S. Patent is directly applied to IIP as communications via the network, encoded data of all code-blocks of all layers are sent from the server to the client in response to each client request, and the server must send even encoded data that have already been received by the client. Furthermore, the header field of encoded data to be sent is rewritten by information (image size, layer information, and the like) of the currently requested image data, and original information managed by the server cannot be acquired.

On the other hand, when the client computer caches encoded data based on JPEG2000, it can form a plurality of received partial encoded data as a data file of one encoded data since it receives partial encoded data from the server. However, in such case, a complicated edit process or the like is required on the client side, and it is not easy to reduce the cost of software that implements required functions.

Also, the client computer can configure partial encoded data received from the server as a cache file of a unique format. However, in such case, a versatile JPEG2000 decoder that runs on the client cannot read this cache file of the unique format.

### SUMMARY OF THE INVENTION

The present invention has been made in consideration of the above prior arts, and has as its object to provide an image processing apparatus for decoding and caching image data segmented in a predetermined format on the basis of that format, and that data cache method.

It is another object of the present invention to provide an encoded data generation method and apparatus, which receive and store segmented encoded data, and can create encoded data according to a display request using the stored encoded data.

It is still another object of the present invention to provide an encoded data generation method and apparatus that can attain a high-speed encoding process.

In order to attain the above described objects, an image processing apparatus of the present invention comprises the structure as follows:

An image processing apparatus for receiving and caching encoded data, which are segmented in a predetermined format, of an image that a user wants, from an external apparatus which is connected via a communication network to allow bidirectional communications, comprising:

reception means for receiving header data associated with the image from the external apparatus prior to reception of the encoded data; calculation means for calculating the number of tiles which form the image, and the number of encoded data required to form each tile on the basis of the header data received by the reception means; dummy data generation means for setting predetermined dummy encoded data in correspondence with the number of encoded data in each of tiles calculated by the calculation means; and data replacement means for replacing dummy encoded data, corresponding to the encoded data actually received from the external apparatus, of the dummy encoded data set by the dummy data generation means, by the encoded data received from the external apparatus.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the descriptions, serve to explain the principle of the invention.

FIG. 1 is a schematic block diagram showing the arrangement of a computer as an image processing apparatus according to an embodiment of the present invention;

FIG. 2 is a schematic view showing a communication network according to the embodiment of the present invention;

FIG. 3 shows the format of JPEG2000 encoded data;

FIG. 4 is a view for explaining resolution scalability of JPEG2000;

FIG. 5 is a view for explaining a communication protocol between a server and client in the embodiment of the present invention;

FIG. 6 is a flow chart showing a cache process of received data in a user terminal according to the first to sixth embodiments of the present invention;

FIG. 7 is a view for explaining the data format of a main file that manages the entire image information in the embodiment of the present invention;

FIG. 8 shows the format of management data for tile data contained in the main file shown in FIG. 7;

FIG. 9 is a flow chart showing a main file creation process in step S603 in FIG. 6;

FIG. 10 is a flow chart showing a tile basic information creation process in step S906 in FIG. 9;

FIGS. 11A and 11B are views for explaining the format of an SOT marker;

FIG. 12 is a flow chart showing a main file overwrite process in step S606 in FIG. 6;

FIG. 13 shows an example of the format of response data from a server;

FIG. 14 shows an example of the format of a cache file in a user terminal in the first embodiment;

FIG. 15 is a flow chart showing a main file creation process according to the second embodiment of the present invention;

FIG. 16 is a flow chart showing a tile basic information creation process in step S1506 in FIG. 15;

FIG. 17 is a flow chart showing a main file overwrite process according to the second embodiment;

FIG. 18 shows the data format of a cache file in a user terminal according to the second embodiment;

FIG. 19 is a flow chart showing a main file creation process according to the third embodiment of the present invention;

FIG. 20 is a flow chart showing a tile basic information creation process in step S1906 in FIG. 19;

FIG. 21 is a flow chart showing a main file overwrite process (S606) in the third embodiment;

FIG. 22 is a view for explaining an example in which packet data according to the fourth embodiment of the present invention are saved in folders for respective tiles;

FIG. 23 is a flow chart showing a main file creation process in the fourth embodiment;

FIG. 24 shows the concept of the cache file configuration in the fourth embodiment;

FIG. 25 shows the concept of cache folders for respective images according to the fourth embodiment;

FIG. 26 is a flow chart showing a process for reading out a cache file in a user terminal according to the fifth embodiment of the present invention;

FIG. 27 is a flow chart showing a process for reading out packet data in step S2607 in FIG. 26;

FIG. 28 is a flow chart showing a process for reading out packet data according to the sixth embodiment of the present invention;

FIG. 29 is a flow chart showing a received data cache process in a user terminal according to the seventh embodiment of the present invention;

FIG. 30 is a view for explaining management data for packet data in a batch cache file according to the seventh embodiment;

FIG. 31 is a view for explaining a state after packet data is written in the batch cache file according to the seventh embodiment;

FIG. 32 is a flow chart showing a batch cache file creation process in step S2903 in FIG. 29;

FIG. 33 is a flow chart showing a tile basic information creation process in step S3205 in FIG. 32;

FIG. 34 is a flow chart showing a cache file overwrite process in step S2906 in FIG. 29;

FIG. 35 is a flow chart showing a process for reading out a batch cache file created in the seventh embodiment in a user terminal according to the eighth embodiment of the present invention;

FIG. 36 is a flow chart showing a process for reading out packet data in step S3507 in FIG. 35 according to the eighth embodiment;

FIG. 37 is a flow chart showing a process for reading out packet data according to the ninth embodiment of the present invention;

FIG. 38 is a block diagram showing the arrangement of a server/client according to an embodiment of the present invention;

FIG. 39 shows an example of encoded data stored in the server according to the embodiment of the present invention;

FIG. 40 is a flow chart for explaining a process in the client according to the embodiment of the present invention;

FIG. 41 is a flow chart for explaining an encoded data creation process in step S4005 in FIG. 40;

FIG. 42 is a flow chart for explaining a progression order determination process in step S4112 in FIG. 41;

FIG. 43 is a flow chart for explaining a “direct copy” process in step S4114 in FIG. 41;

FIG. 44 is a flow chart for explaining a “conversion copy” process in step S4115 in FIG. 41;

FIG. 45 shows an example of a processing result according to the 10th embodiment of the present invention;

FIG. 46 shows an example of a processing result in another case of the 10th embodiment of the present invention;

FIGS. 47A and 47B are views for explaining an example of the tile format according to the 11th embodiment of the present invention;

FIG. 48 is a flow chart showing an encoded data generation process according to the 11th embodiment of the present invention;

FIG. 49 is a flow chart showing a tile output process in step S4866 in FIG. 48;

FIG. 50 is a flow chart showing a header output process in step S4973 in FIG. 49;

FIG. 51 shows an example of a processing result in the 11th embodiment of the present invention;

FIG. 52 is a flow chart showing an image request operation of a client according to the 12th embodiment of the present invention;

FIGS. 53A to 53C show an example of resolution scalability and tile segmentation of JPEG2000;

FIG. 54 shows an example of the format of encoded data in units of packets of JPEG2000;

FIG. 55 is a flow chart showing a process for generating encoded data of a display file according to the 12th embodiment;

FIG. 56 is a view for explaining the state of encoded data of non-display tiles in the generated display file;

FIG. 57 is a view for explaining the state of encoded data of display tiles in the display file upon displaying resolution level 0;

FIG. 58 is a flow chart showing an image request operation of a client according to the embodiment of the present invention;

FIG. 59 is a flow chart showing a process for generating a display file of encoded data in the 13th embodiment;

FIG. 60 is a view for explaining cache data and display file data in the 13th embodiment; and

FIG. 61 is a view for explaining the process upon generating display file data according to the 13th embodiment of the present invention.

### DETAILED DESCRIPTION OF THE PREFERRED EMBODIMENTS

Preferred embodiments of the present invention will be described in detail hereinafter with reference to the accompanying drawings.

<First Embodiment>

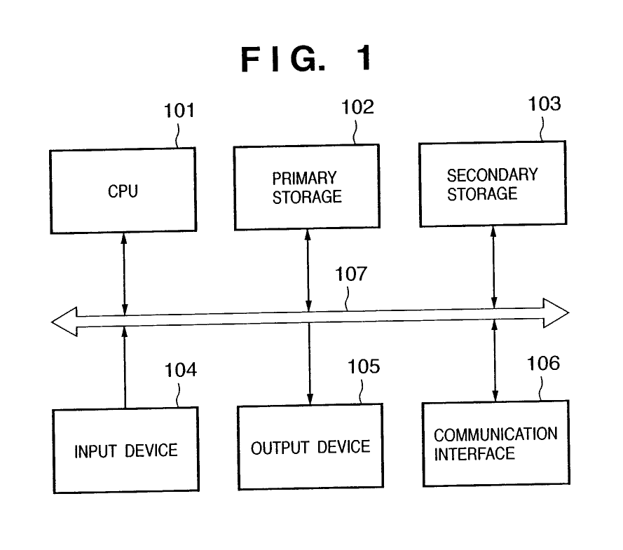

FIG. 1 is a schematic block diagram showing the arrangement of a computer as an image processing apparatus according to the first embodiment of the present invention.

Referring to FIG. 1, a CPU 101 executes programs stored in a primary storage unit 102 to control the operations of the entire computer. In this embodiment, the primary storage unit (to be abbreviated as a primary storage hereinafter) 102 mainly assumes a memory as an example of storage media, and loads and stores programs and the like stored in a secondary storage unit (to be abbreviated as a secondary storage hereinafter) 103. The secondary storage 103 may use a storage medium such as a hard disk or the like.

The size of data that can be stored in the primary storage 102 is normally smaller than that which can be stored in the secondary storage 103, and programs, data, and the like that cannot be stored in the primary storage 102 are stored in the secondary storage 103. Also, data and the like that must be stored for a long period of time are stored in the secondary storage 103. In this embodiment, software programs that describe operation control processes of this computer are stored in the secondary storage 103, and such software programs are loaded onto the primary storage 102 prior to execution by the CPU 101.

An input device 104 includes, for example, an auxiliary input device such as a mouse or the like, and an input device such as a keyboard or the like, and is used to set user's operations in the computer. An output device 105 includes, for example, a monitor, printer, and the like. Reference numeral 106 denotes a communication interface which can make bidirectional communications with an external apparatus.

These units shown in FIG. 1 are interconnected via an internal bus 107 to be able to exchange data with each other, so as to implement the operation control of the entire computer by the CPU 101.

Various other arrangements of computers may be used as the image processing apparatus according to this embodiment. However, a currently available general computer and its peripheral devices can be used, and a detailed description thereof in this embodiment will be omitted.

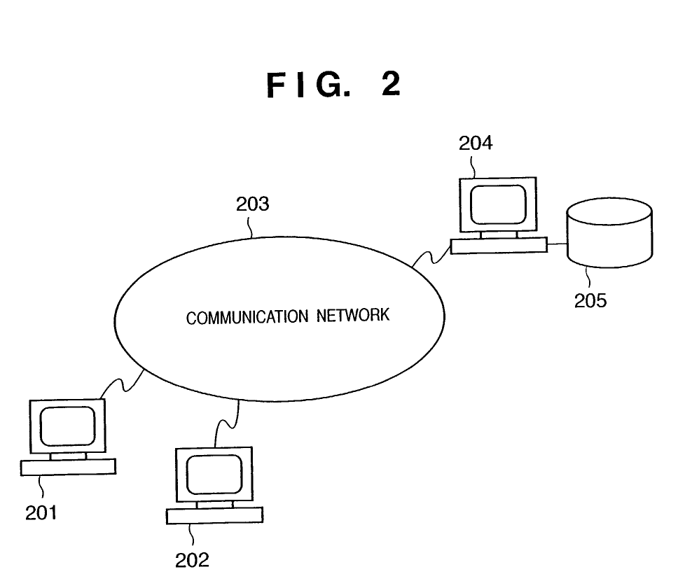

FIG. 2 schematically shows a communication network in the embodiment of the present invention, i.e., shows a so-called a server-client environment.

Referring to FIG. 2, reference numerals 201 and 202 denote user terminals serving as clients. Each individual user terminal comprises the computer (computer system) as the image processing apparatus, that has been explained above with reference to FIG. 1. The user terminals 201 and 202 and a server 204 can make data communications with each other via a general communication network (to be simply referred to as a network hereinafter) 203 including the Internet.

The server computer (to be simply referred to as a server hereinafter) 204 comprises a large-capacity storage device 205 such as a hard disk or the like for accumulating image files. In this embodiment, the storage device 205 stores many image data that have been encoded in advance according to the JPEG2000 encoding method.

In the following description, a method of caching a data file of encoded image data (encoded data) which is encoded according to the JPEG2000 encoding method in the user terminal 201 (202) will be explained in detail using practical examples. This embodiment will exemplify a case wherein the user of the user terminal 201 (202) accesses a desired home page via the network 203 while operating a Web browser that runs on the user terminal, and clicks (selects) a link to JPEG2000 image data contained in that home page, so that the user can acquire that image data with a size and resolution he or she wants, and displays it on a display of the user terminal.

To help easy understanding of the cache method according to this embodiment, general JPEG2000 encoded data will be briefly explained below.

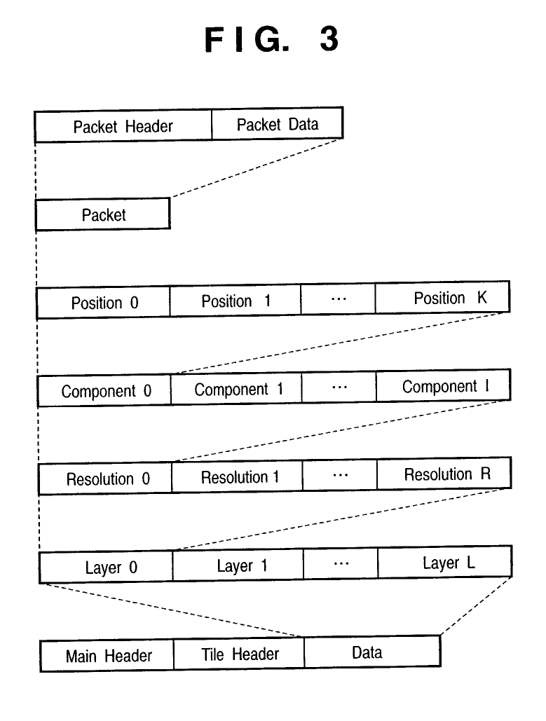

FIG. 3 shows the format of JPEG2000 encoded data, i.e., the structure of a JPEG2000 file (a JPEG2000 encoded data file), which is recorded according to Layer-resolution level-component-position progression (to be abbreviated as LRCP hereinafter).

According to this LRCP, in general, a JPEG2000 file is recorded in various storage media in the order of layer/resolution/component/position data blocks. Such arrangement (layout) of data blocks is called a progression order. The concept of “position” is considered in the art of “precinct” in JPEG2000. In frequency components with respect to each resolution obtained by the wavelet transform, even if the frequency components have different frequency, if the frequency components are the same type/same level in layer/resolution/component, those are successively arranged in line as a group of data indicating a position of a small area in which an original image is divided.

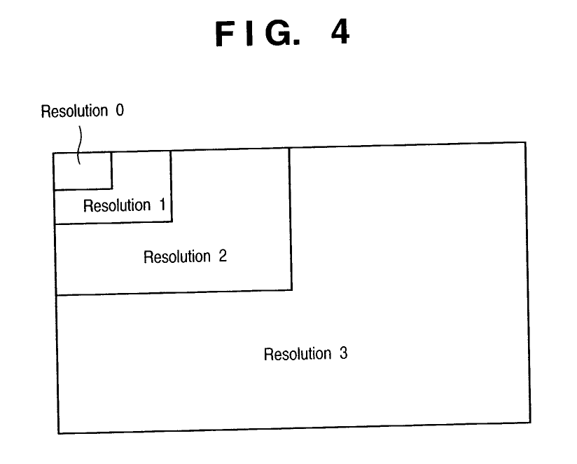

FIG. 4 is a view for explaining resolution scalability of JPEG2000, and shows the relationship between the resolutions (image sizes) and resolution numbers.

As shown in FIG. 4, the resolution number of an image with the lowest resolution is set to be “0”, and the width and height of the image size are doubled as the resolution number increases by 1.

In the structure of encoded data shown in FIG. 3, each layer corresponding to a layer number stores data in ascending order of resolution number. The layer number corresponds to the S/N ratio of an image to be reconstructed to its original image (source image), and the S/N ratio with respect to the original image impairs as an image has a smaller layer number.

In one JPEG2000 file, the maximum values of the resolution number, layer number, and component number are set in advance by an encoder complying with JPEG2000, and these parameters are stored in encoded data. Each packet is made up of a packet header field that manages information of code-blocks stored in that packet, and encoded data of code-blocks.

[Creation of Cache File]

When JPEG2000 encoded data shown in FIGS. 3 and 4 is stored as a file in the user terminal 201 (202) according to a cache sequence to be described below in this embodiment, the user can receive only encoded data of his or her required part (resolution) from the server, and can efficiently browse an image, in place of acquiring all encoded data corresponding to desired image present in the server 204 by the user terminal.

As a unit of received data in the user terminal, a packet of JPEG2000 or a code-block as an encoding unit smaller than the packet may be used. In this embodiment, a packet is assumed as a data unit that the user terminal receives from the server 204.

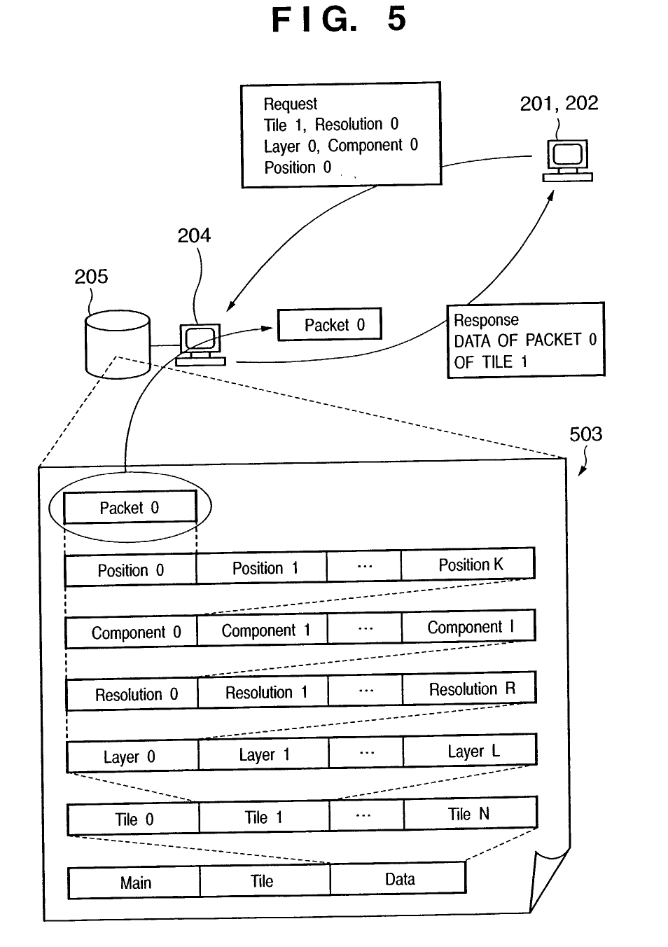

FIG. 5 is a view for explaining a communication protocol between the server and client in the embodiment of the present invention, and shows the concept of a request and response for each packet.

Referring to FIG. 5, the user terminal 201 (202) designates an image tile number, resolution level, layer, component, and position numbers in accordance with user's selection operations, and sends a request of corresponding image data to the server 204. Upon receiving this request, the server 204 analyzes a code stream of image data 503 (having the same data structure as that shown in FIG. 3) stored in the storage device 205, then extracts packet data corresponding to the tile number, resolution level, layer, component, and position numbers designated by the user terminal, and sends the extracted packet data to the user terminal. The operation of the user terminal, which can implement a series of such operations, will be explained below.

In the example shown in FIG. 3, the user terminal requests data of tile 1, resolution 0, layer 0, component 0, and position 0, and data of packet 0 of tile 1 including them is sent back from the server 204 to the user terminal.

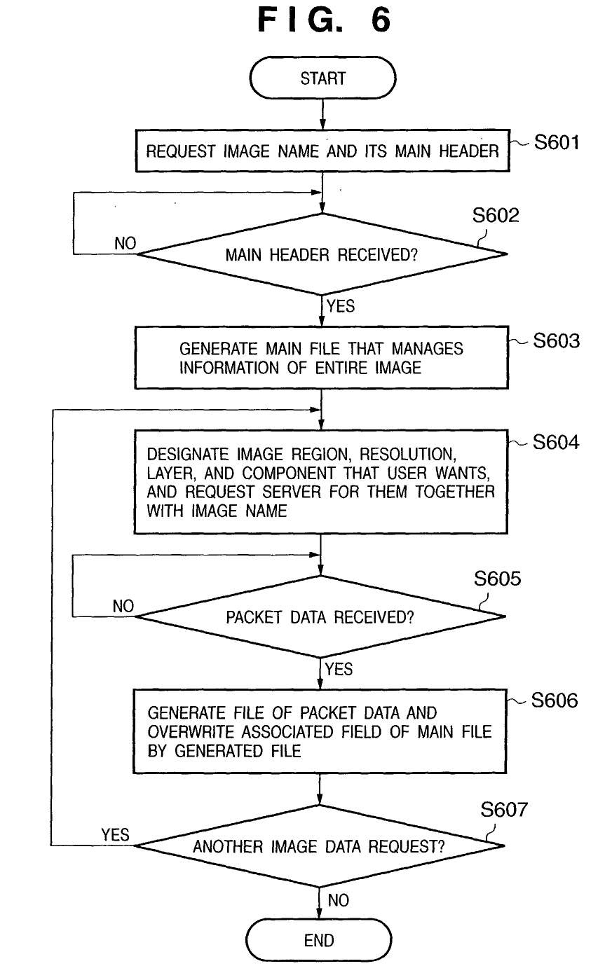

FIG. 6 is a flow chart showing a received data cache process in the user terminal (201 or 202) according to the first to sixth embodiments of the present invention, and shows a sequence described in a software program to be executed by the CPU 101.

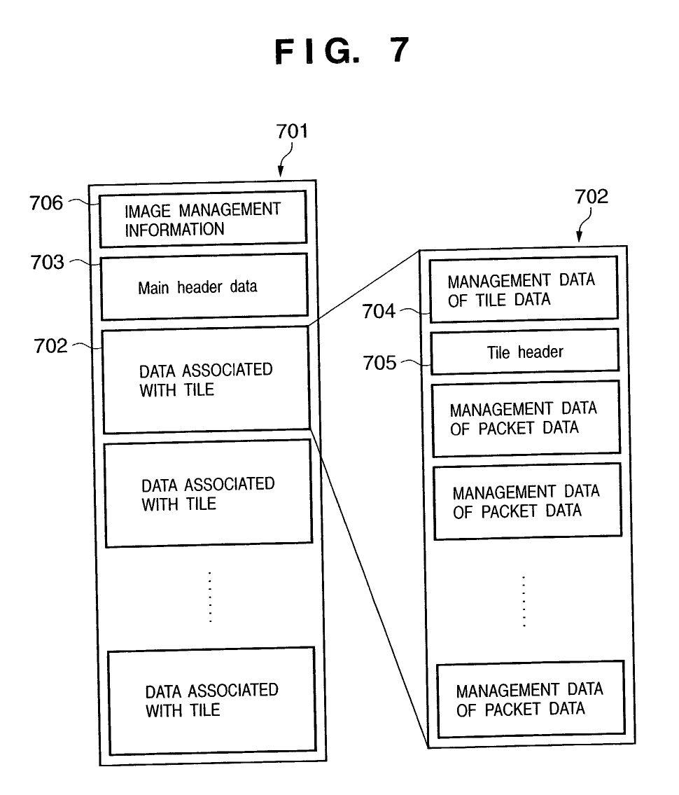

Referring to FIG. 6, the user terminal requests the server 204 that stores a plurality of images for a required image name and the main header of that image data via the network 203 in step S601. The flow advances to step S602 to check if the main header sent from the server 204 in response to the request in step S601 is received. If YES in step S602, the flow advances to step S603. In step S603, the user terminal creates a file (to be referred to as a main file hereinafter) 701 used to manage information of the entire image and a cache file, as shown in FIG. 7, on the basis of the received main header, and writes the main header acquired in step S602 in a field 703 of the main file 701.

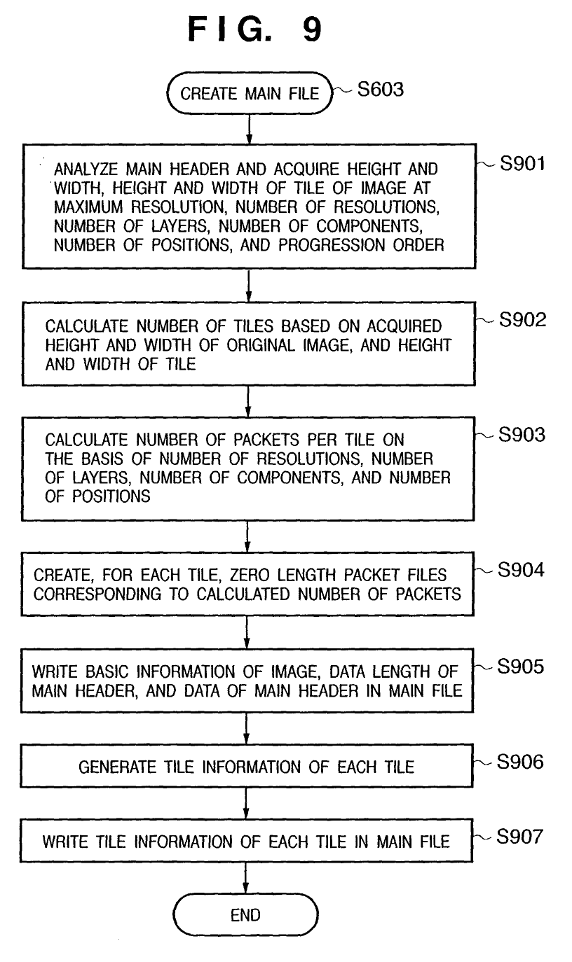

More specifically, upon receiving the main header, the user terminal prompts the user to input a file name so as to create a main file 701, which is used to manage information of the entire image having the data format shown in FIG. 7, and has a file name, in which the name of the original image is inserted at its head position, in a desired area (e.g., a Temp folder of a C drive) of the secondary storage 103 in step S603. For example, when the user requests a file “image.jp2”, that user terminal creates a main file 701 with a name “image.iip2k” in the folder of the secondary storage 103 (note that details of the process in step S603 will be explained later with reference to FIG. 9).

The flow then advances to step S604 to request the server 204 for the required image region, resolution, layer, and component according to user's selection operations at the user terminal via the network 203. Since user's selection operations in step S604 are not related to the gist of the cache method as the principal object of the present application, a description thereof will be omitted.

In response to this request, the server 204 sends an image portion designated by the user terminal to the user terminal for respective packets of JPEG2000.

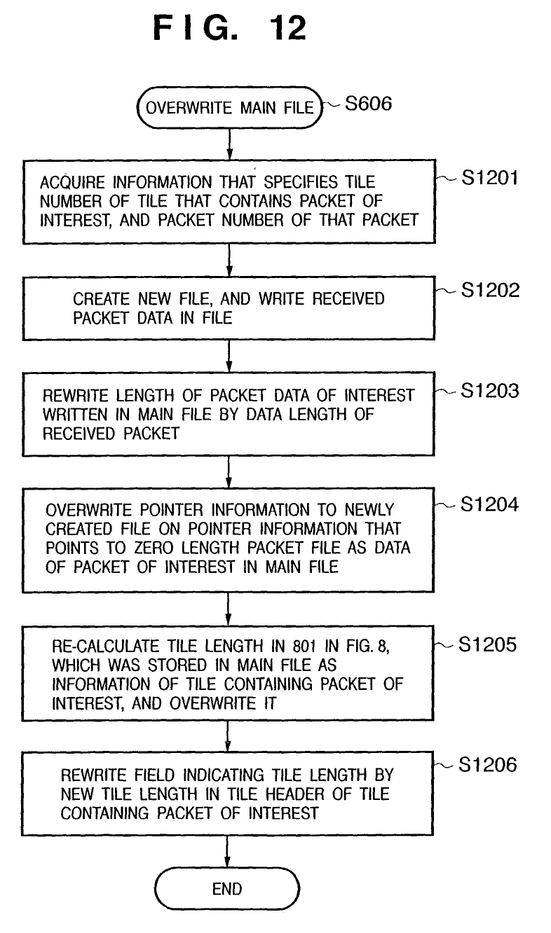

The flow advances to step S605, and if it is determined in step S605 that the packet data is received, the flow advances to step S606 to form the received packet data as a file, and to rewrite the contents of a field that describes information associated with the packet data in the main file 701 created in step S603 (note that details of the process in step S606 will be explained later with reference to FIG. 12).

The flow advances to step S607 to check if the user has requested another image data. If YES in step S607, the flow returns to step S604; otherwise, the control returns.

FIG. 9 is a flow chart showing the main file creation process (step S603) in the first embodiment of the present invention.

Referring to FIG. 9, the main header received from the server 204 is analyzed in step S901 to acquire the height and width of an original image, the height and width of a tile at a maximum resolution and the number of resolution levels, the number of layers, the number of components, the number of positions, and the progression order. The flow advances to step S902 to calculate the number of tiles on the basis of the height and width of the original image, and the height and width of a tile at the maximum resolution. The flow advances to step S903 to calculate the number of packets contained per tile on the basis of the number of resolution levels, the number of layers, the number of components, and the number of positions acquired in step S901. The flow advances to step S904 to create files each of which stores a 1-byte value “0” indicating “zero length packet” in JPEG2000 encoded data (to be referred to as “zero length packet” file hereinafter) in correspondence with the number of packets contained per tile, which is obtained in step S903. For example, a file which has a name “image_tile00000_pkt0002.iip2k” and stores a 1-byte value “0” is created in the Temp folder under the C drive (C:/Temp/) for a packet with tile number “0” and packet number “2” in the aforementioned file “image.jp2”. That is, in step S904 the main file 701, which has a value (dummy encoded data) indicating a “zero length packet” specified by the bit-stream syntax of JPEG2000 for each packet is created.

The flow advances to step S905, basic information of the original image such as the number of tiles, the number of resolution levels, the number of layers, the number of components, and the like, which are obtained by analyzing the main header in step S901, and the data length of the main header are written in a field 706 of the main file 701 as image management information. Note that a field 703 of the main file 701 stores the data of the received main header.

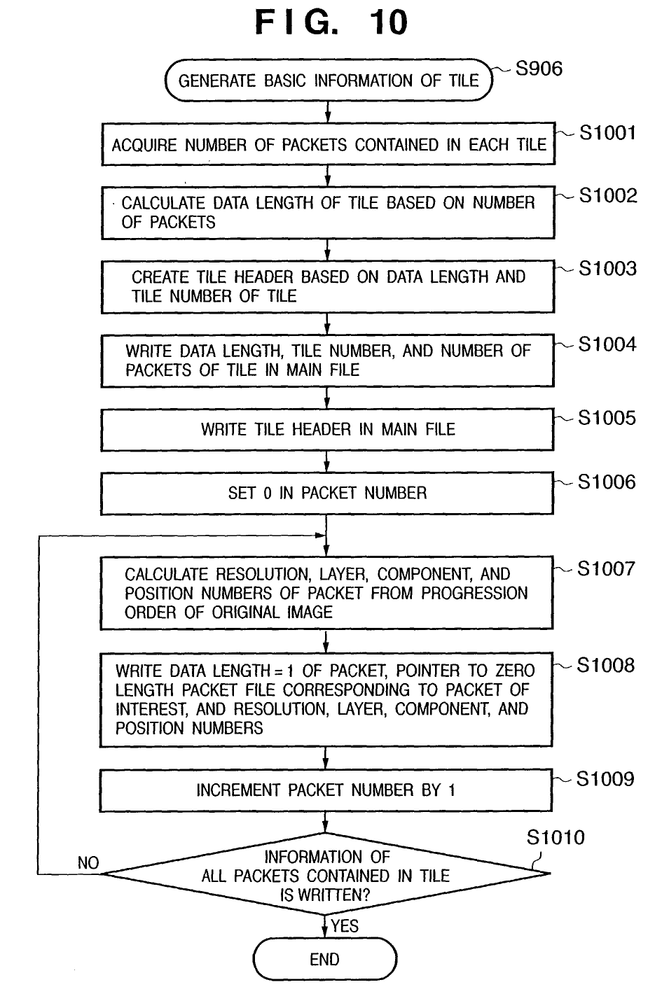

The flow advances to step S906 to create basic information of each tile in a field 702 of the main file 701, as shown in the right enlarged view of FIG. 7 (note that details of the process in step S906 will be described later with reference to FIG. 10). The flow then advances to step S907 to write the basic information of each tile created in step S906 in the field 702 of the main file 701, thus ending the main file creation process.

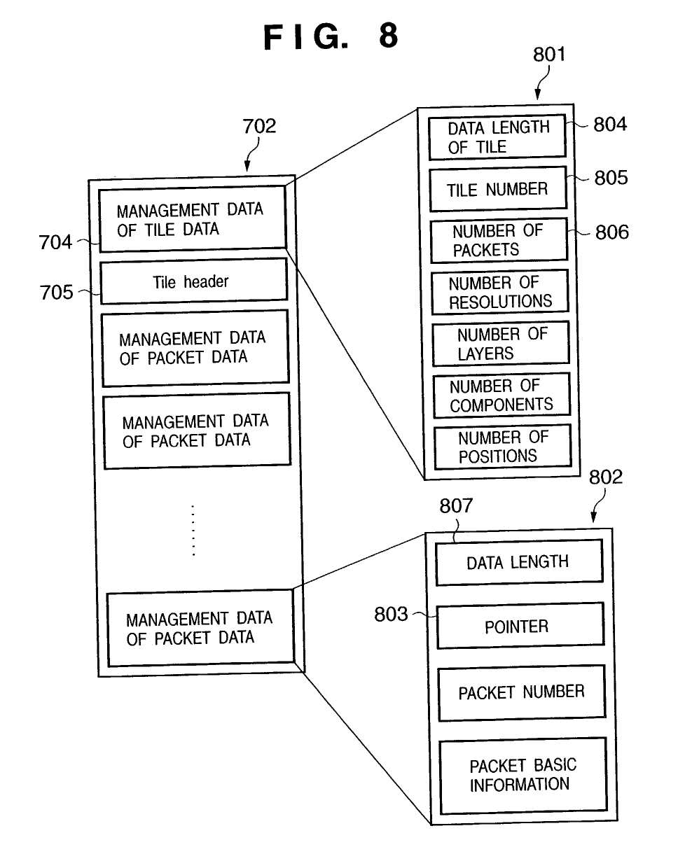

FIG. 10 is a flow chart showing the tile basic information creation process (step S906) according to the first embodiment. The flow chart in FIG. 10 shows a process executed only when the main file 701 is created, and this process is executed in only an initial state. In step S906, the operations in the flow chart shown in FIG. 10 are repeated in correspondence with the number of tiles in the order of tile numbers, thus creating fields 702 of the main file 701 shown in FIG. 7. Also, this field 702 has a format shown in detail in FIG. 8.

Referring to FIG. 10, the number of packets contained per tile, which has already been calculated in step S903 in FIG. 9, is acquired in step S1001. At this time, the user terminal has not received any packet data from the server 204 yet, and all packets of the main file 701 are zero length packets since the process in step S904 above is executed. Hence, in step S1002, the data length of each tile is calculated by:

(length of tile header)+(number of packets contained in tile)×1 byte

For example, if a marker contained in the tile header is only an SOT marker, and one tile contains 36 packets, the data length of this tile is 14+1×36=50 [bytes].

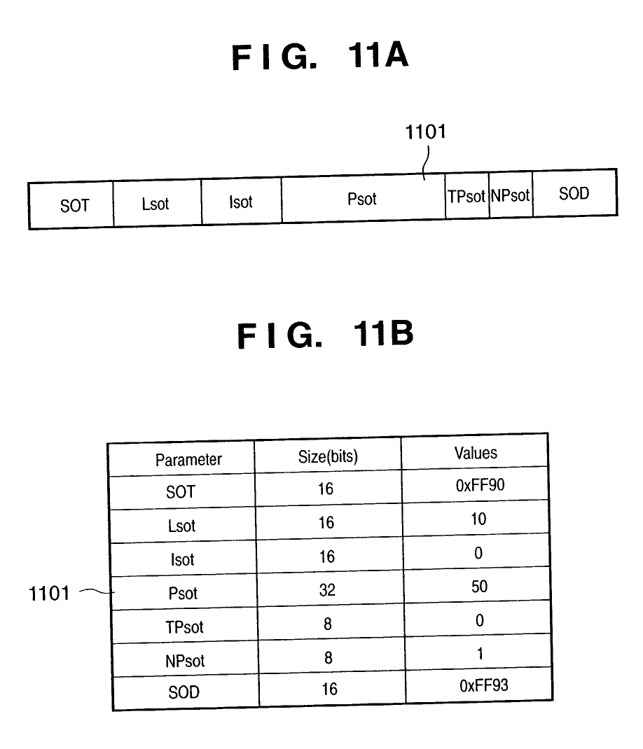

The flow advances to step S1003 to create an SOT marker to be contained in the tile header in JPEG2000 on the basis of the tile number and the data length of a tile. FIGS. 11A and 11B show the format and data size of the SOT marker created for a tile which has tile number “0” and contains “36” packets.

The flow advances to step S1004 to write a data length 804 of a tile, tile number 805, the number 806 of packets contained in the tile, and the number of resolutions, the number of layers, the number of components, and the like that the tile contains in management data 704 of tile data. The flow then advances to step S1005 to write the tile header in a field 705 of the main file 701. The flow advances to step S1006 to set “0” in the packet number, and processes in step S1007 and subsequent steps are repeated in the order of packet numbers.

In step S1007, the resolution level, layer, component, and position numbers corresponding to the packet number are specified in accordance with the progression order of the original image. The flow advances to step S1008 to write a data length=1 of the packet of interest, a pointer to a zero length packet file corresponding to this packet data, and information required upon managing the packet of interest such as the resolution level, layer, component, and position numbers, and the like in a field 802 of the field 702 of the main file 701. At this time, as the pointer to the zero length packet file, a value that specifies data of the packet of interest such as a file name “image_tile0000_pkt0002.iip2k” or the like is written in a field 803. The flow advances to step S1009 to increment the packet number of the packet of interest by 1, and it is then checked in step S1010 if a series of processes starting from step S1007 are complete for all packets contained in that tile. If YES in step S1010, this operation ends. For example, when the number of packets is “36”, if the packet number after step S1009 is “36”, this flow chart ends. That is, in the initial state, the user terminal caches a data file having zero length packet data so many as packets contained in the image file in the server 204.

When data in the cache file created by the processes described so far are sequentially sent to a JPEG2000 decoder of the user terminal, they can undergo a decode process while the image size and the like as basic information of image data remain the same as condition values. That is, the decoder determines that all packets are “empty”, and they can be decoded.

FIG. 12 is a flow chart showing the overwrite process of the main file 701 in step S606 in FIG. 6 according to the first embodiment of the present invention.

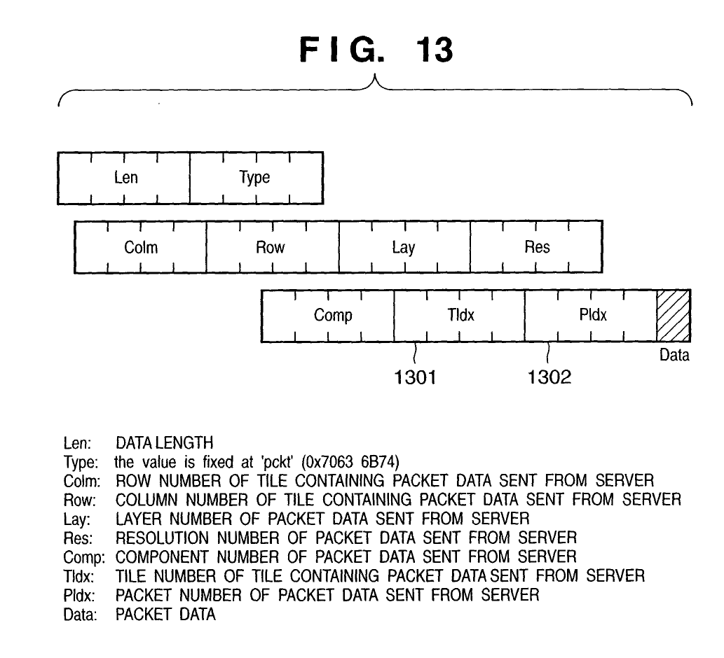

Referring to FIG. 12, the tile number of a tile that contains the received packet data, and the packet number of that packet data are acquired in step S1201. For example, when response data in a binary format shown in FIG. 13 is sent from the server 204 to the user terminal, TIdx (1301) and PIdx (1302) respectively indicate the tile number of a tile which contains the received packet data, and the packet number of that packet data, and these values are used in step S1201. This response data is not limited to the binary format but may have a text format such as XML. In step S1202, a file in which the received packet data is written is created in that folder in which the main file 701 was created. For example, since the zero length packet file with the name “image_tile00000_pkt002.iip2k” has already been created in the Temp folder under the C drive in correspondence with the packet with tile number “0” and packet number “2” of the file “image.jp2” in step S904 in FIG. 9, that file is rewritten by the newly received packet data.

In step S1203 and subsequent steps, information associated with this packet (packet of interest) in the main file 701 is rewritten. In step S1203, the contents of a field 807 in which “1” was written as the data length of the packet of interest upon creation of the main file 701 are rewritten by the data of the packet data actually received from the server 204. The flow advances to step S1204, pointer information 803 which points to a zero length packet file corresponding to the packet of interest is rewritten by that to the file created in step S1202 as the file that stores the packet data of interest. For example, when the file name is written as pointer information to the file, the zero length packet file with the name “image_tile00000_pkt0002.iip2k” is created for the packet with tile number “0” and packet number “2” of the file “image.jp2” in step S904 in FIG. 9, and the received packet is overwritten on that file in step S1202 in FIG. 12, the pointer information need not be rewritten.

The flow advances to step S1205 to re-calculate the data length of a tile that contain the packet of interest, and to rewrite the contents of the field 804 that describes the data length of the tile of the main file 701 indicated by the field 801 in FIG. 8. For example, if only one packet data is updated per process, and the number of bytes of the currently received new packet data is 512 bytes, the value of the tile data length in the field 804 in FIG. 8 is updated to the value added to “511” (=512−1), since “1” need only be subtracted from the old value and the number of newly received bytes “512” need only be added to that difference. The flow advances to step S1206, and a field that describes the tile data length of an SOT marker 705 of the tile that contains the packet data, i.e., Psot (1101) in FIG. 11, is updated by the value overwritten on the field 804.

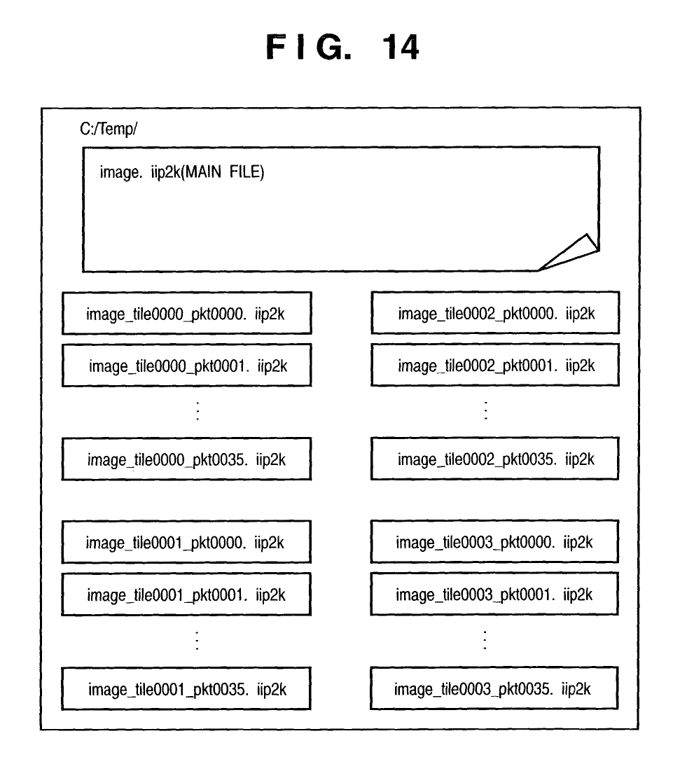

Therefore, when, for example, the number of tiles is “4” and the number of packets per tile is “36”, a file shown in FIG. 14 is created in the Temp folder under the C drive of the user terminal. The number of cache files (1+36×4)=145 and the file names in FIG. 14 remain the same since the user created the main file 701 and zero length packet files in step S603 in FIG. 6.

When the cache method according to the first embodiment is executed on the user terminal 201 (or 202), even when not all image data (differential encoded data) prepared in the server 204 are received, non-received packet data in the main file 701 is stuffed by zero length packets at the process in step S904 in FIG. 9, thus storing the received data as a stream complying with the predetermined format of JPEG2000. Therefore, when the user terminal receives partial data, the main header and tile headers contained in the created main file 701 are combined into a single file as each individual packet data without rewriting the main header received from the server 204, thus easily forming a file that can be decoded by a general JPEG2000 decoder at the user terminal.

<Second Embodiment>

In the first embodiment, zero length packet files are created in correspondence with packets which are not received by the user terminal 201 (or 202). However, all these zero length packet files have the same data. For this reason, one zero length packet file may be created for one image, and all packets, packet data of which are not received, may refer to that file. In this case, the main file creation process in step S603 in the flow chart that shows the cache creation process on the client side (user terminal) shown in FIG. 6, and the process for rewriting the main file in step S606 after reception of packet data are different from the first embodiment. In the second embodiment, these processes will be explained.

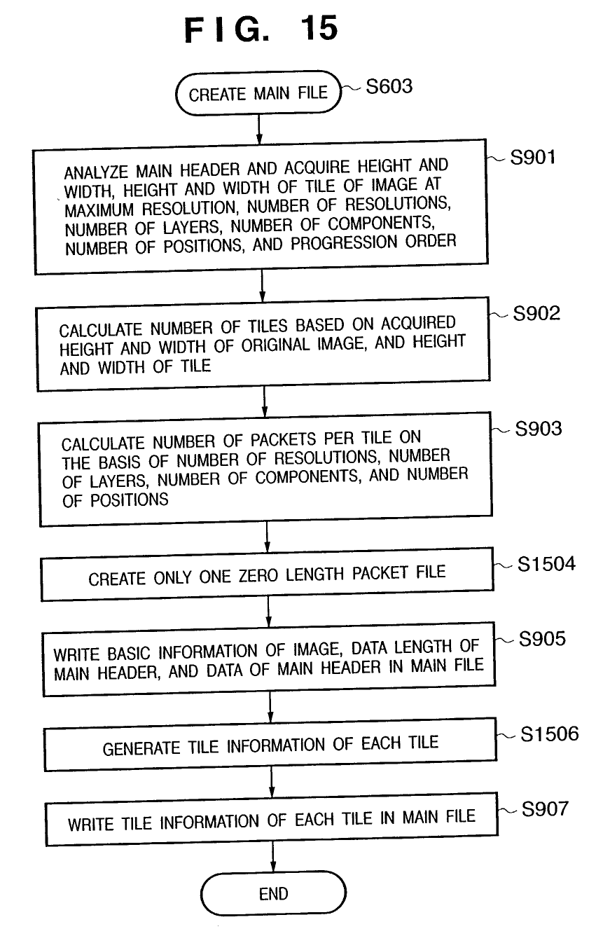

FIG. 15 is a flow chart showing the creation process of the main file 701 according to the second embodiment of the present invention. Since the processes in steps S901 to S903, and steps S905 and S907 are the same as those with the same step numbers in the first embodiment described with reference to FIG. 9, a description thereof will be omitted.

In step S1504, only one file that stores a 1-byte value “0” which indicates a zero length packet in JPEG2000 encoded data, i.e., a zero length packet file, is created. For example, a file with a name “image_zero.iip2k” is created for, e.g., a file “image.jp2” in that Temp folder under a C drive where a main file “image.iip2k” is stored. That is, one zero length packet file is created per image.

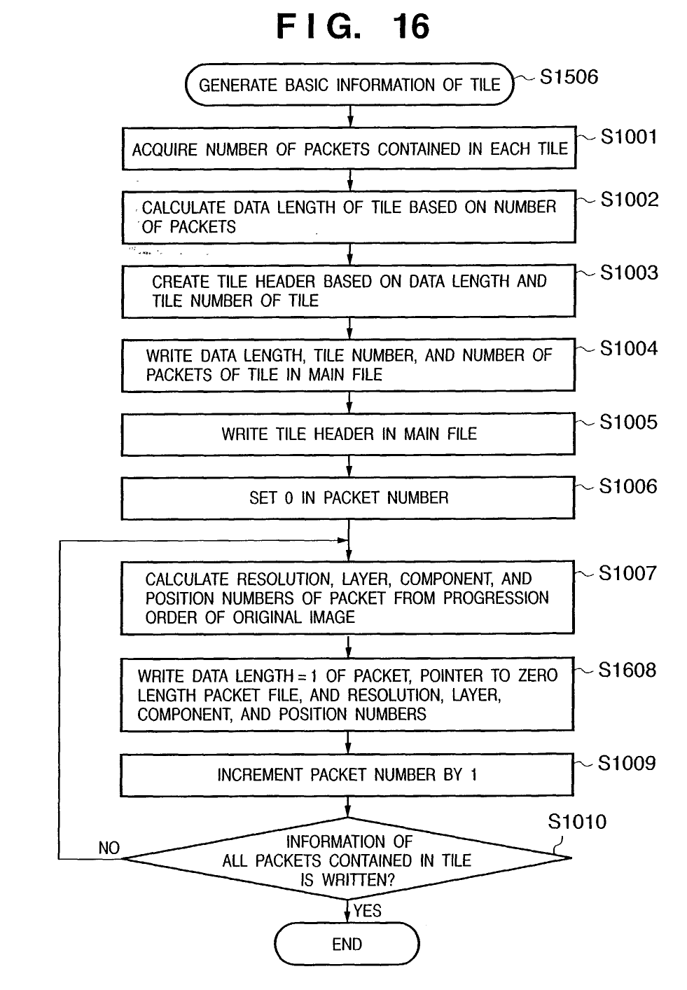

In step S1506, basic information of each tile shown in the field 702 in FIG. 7 is created. Since this basic information has a format slightly different from that created in the first embodiment, it will be explained below with reference to FIG. 16.

FIG. 16 is a flow chart showing the tile basic information creation process (step S1506) according to the second embodiment. Since processes in steps S1001 to S1007, and steps S1009 and S1010 are the same as those with the same step numbers in the first embodiment described with reference to FIG. 10, a description thereof will be omitted.

The flow chart shown in FIG. 16 shows the process executed only when the main file 701 is created, and this process is executed in only an initial state.

In step S1506 in FIG. 15, the operations in the flow chart shown in FIG. 16 are repeated in correspondence with the number of tiles in the order of tile numbers, thus creating the contents of the fields 702 shown in FIG. 7. This field 702 has a format shown in detail in FIG. 8.

In step S1608, a data length=1 of the packet of interest, a pointer to the zero length packet file, and information required upon managing the packet of interest such as the resolution level, layer, component, and position numbers, and the like, are written in the field 802 of the main file 701. For example, as the pointer to the zero length packet file, a value that specifies a file which stores that packet data such as a file name (e.g., “image_zero.iip2k”) is written in a field 803.

In the second embodiment, since only one zero length packet file is created, as described above, the pointer to all packet data files written in the main file 701, i.e., a destination to which the contents of the field 803 in FIG. 8 point, is “image_zero.iip2k” in the initial state.

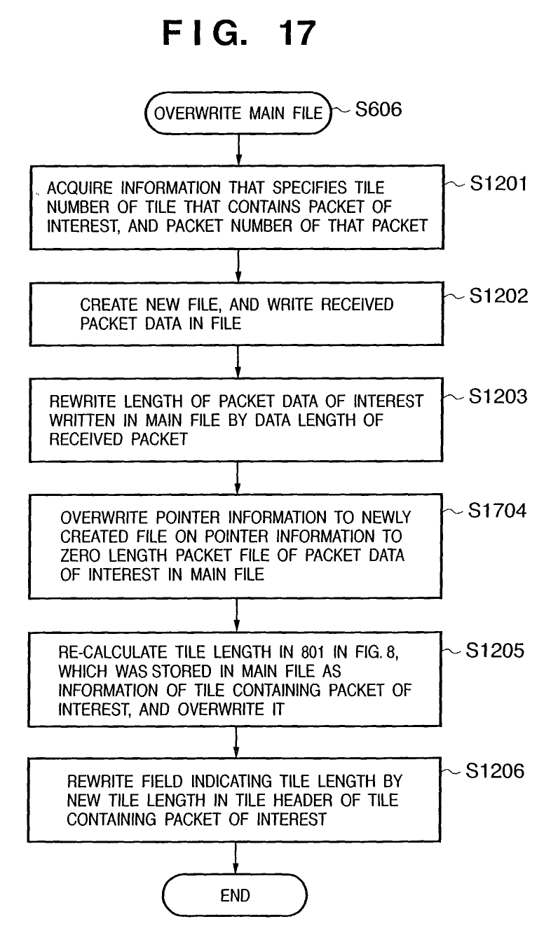

The overwrite process (step S606 in FIG. 6) of the main file 701 in the second embodiment will be described below with reference to FIG. 17.

FIG. 17 is a flow chart showing the overwrite process of the main file according to the second embodiment of the present invention. Since processes in steps S1201 to 1203, and steps S1205 and S1206 are the same as those with the same step numbers in the first embodiment described with reference to FIG. 12, a description thereof will be omitted.

In step S1704, information of the pointer 803 that points to the zero length packet file as a file that stores data of the packet of interest is rewritten by pointer information to a file created in step S1202. For example, the file name “image_zero.iip2k” written in the pointer 803 is rewritten by a file name “image_tile00000pkt0002.iip2k” of the newly created file.

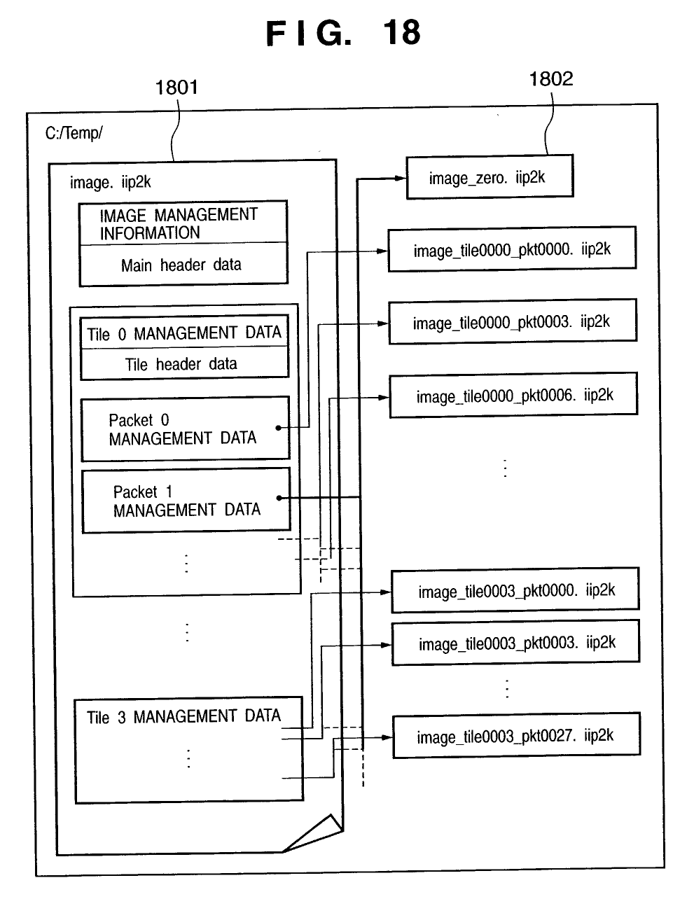

FIG. 18 shows the format of cache files created on the user terminal according to the second embodiment. With such cache file format, only two files, i.e., a main file 1801 and zero length packet file 1802, are created in an initial state. In the initial state, as the pointer 803 that points to packet data files in the main file 701, pointer information to the zero length packet file 1802 is written in all packets. After that, every time packet data is received from the server 204, the number of files increases. In this manner, the number of files to be created can be reduced compared to the sequence according to the first embodiment described above.

<Third Embodiment>

In the first and second embodiments, a 1-byte zero length packet file is created in correspondence with a packet that the user terminal 201 (or 202) has not received yet. However, a value indicating packet data which is not received yet may be stored in the packet data management field 801 of the main file 701, and a 1-byte value “0” may be returned every time a file is read out. Hence, the third embodiment will explain a method that does not create any zero length packet file unlike in the first and second embodiments described above.

In the processing configuration according to the third embodiment, the main file creation process executed in step S603 in the flow chart that shows the cache creation process shown in FIG. 6 and the overwrite process of data associated with a received packet in step S606 are different from those in the first and second embodiments.

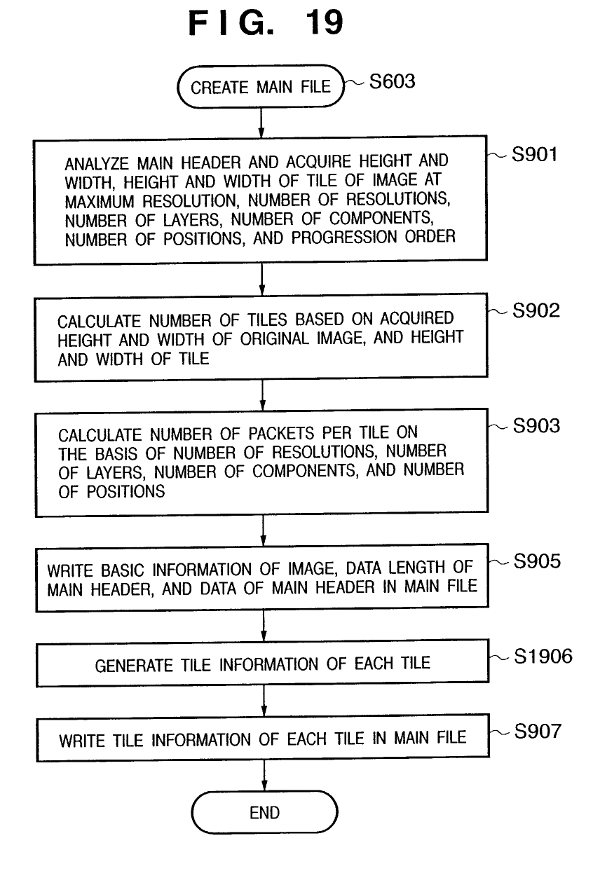

FIG. 19 is a flow chart showing the creation process of the main file 701 (corresponding to step S603 in FIG. 6) according to the third embodiment of the present invention. Since processes in steps S901 to S903, and steps S905 and S907 are the same as those with the same step numbers in the first embodiment described with reference to FIG. 9, a description thereof will be omitted.

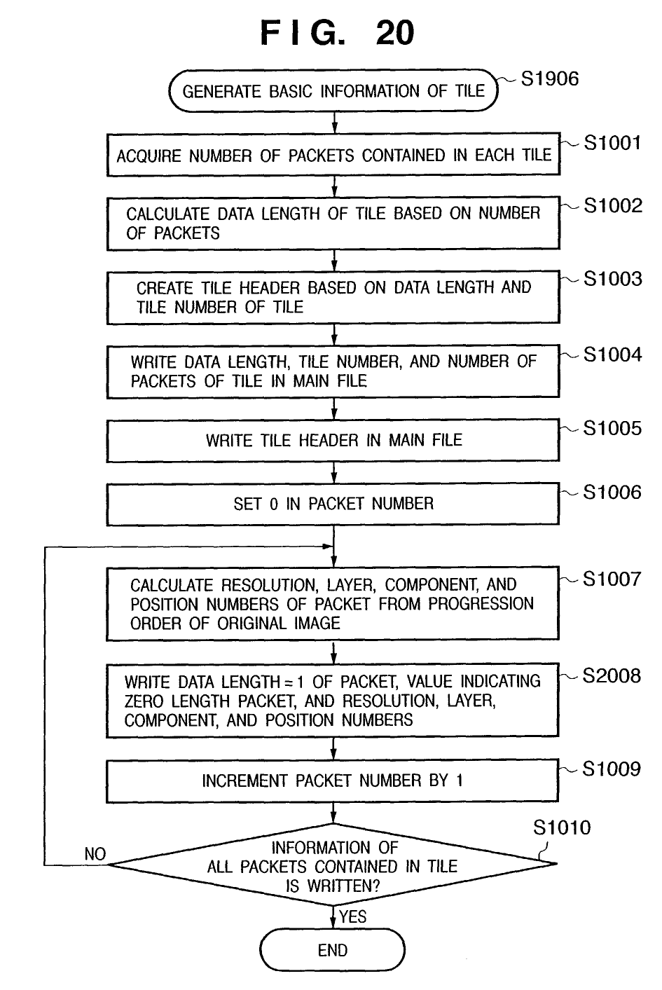

That is, in the main file creation process of the third embodiment, step S904 in FIG. 9, i.e., the step of creating a zero length packet file associated with a non-received packet, can be omitted. In correspondence with this processing configuration, in the third embodiment, tile basic information created in step S1906 in FIG. 19 is different from those in the first and second embodiments. Hence, the tile basic information creation process in the third embodiment will be described below with reference to FIG. 20.

FIG. 20 is a flow chart showing the tile basic information creation process (S1906) according to the third embodiment. Since processes in steps S1001 to S1007, and steps S1009 and S1010 are the same as those with the same step numbers in the first embodiment described with reference to FIG. 10, a description thereof will be omitted.

In step S2008, a data length=1 of the packet of interest, a value indicating that this packet is a zero length packet, and information required upon managing the packet of interest such as the resolution level, layer, component, and position numbers, and the like, are written in the field 802 of the main file 701. As the value indicating the zero length packet file, for example, NULL or the like may be written in the field 803.

In the third embodiment, since no file for a zero length packet is created, only the main file 701 is created on the user terminal in an initial state upon ending the process in the flow chart shown in FIG. 20.

When data and values “0” corresponding to respective packets in the cache file created by the process described so far are sequentially sent to a JPEG2000 decoder of the user terminal according to the description of the main file 701, they can undergo a decode process while the image size and the like as basic information of image data remain the same as condition values. That is, the decoder determines that all packets are “empty”, and they can be decoded.

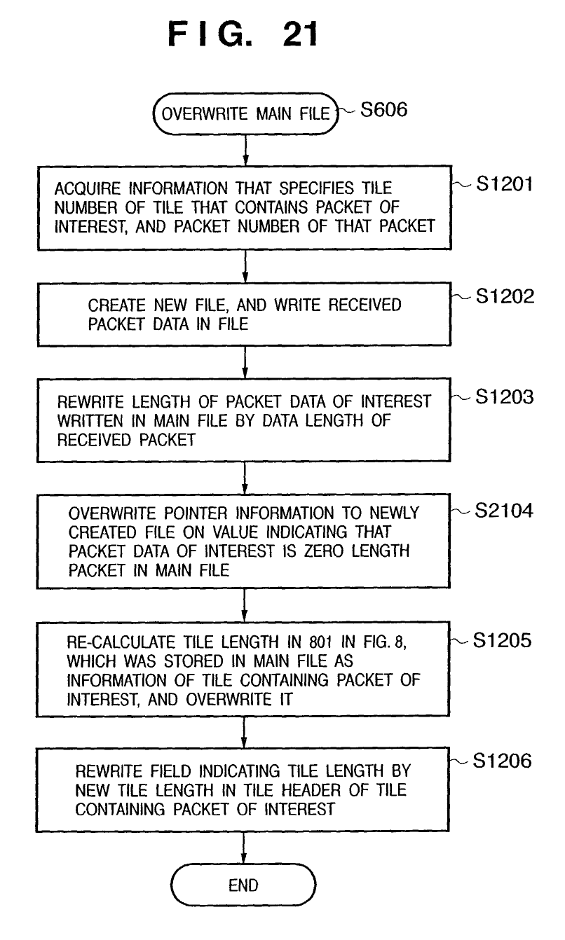

FIG. 21 is a flow chart showing the main file overwrite process (S606) according to the third embodiment. Since processes in steps S1201 to S1203 and steps S1205 and S1206 are the same as those with the same step numbers in the first embodiment described with reference to FIG. 12, a description thereof will be omitted.

In step S2104, the contents of the field 803 that stores the value indicating that the packet of interest is a zero length packet are rewritten by pointer information to a file created in step S1202. For example, the contents of the field 803 that stores the value “NULL” indicating a zero length packet are rewritten by a name “image_tile00000_pkt0002.iip2k”.

According to the third embodiment in which such cache method is executed on the user terminal, since only the main file 701 and files of received packets are created, the number of files to be created can be reduced compared to the first and second embodiments.

<Fourth Embodiment>

In the first to third embodiments described above, all files are created under a single folder. However, when a larger number of packets are received from the server, these packets may be distributed to a plurality of folders upon management.

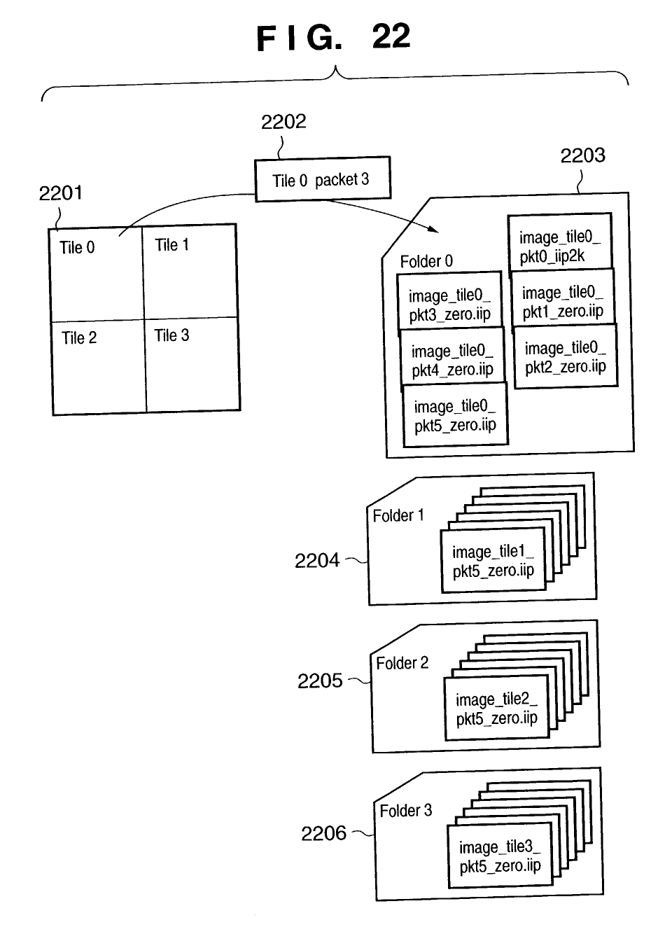

FIG. 22 is a view for explaining an example in which packet data are saved in folders for respective tiles according to the fourth embodiment of the present invention. In this example, files of packet data contained in a single tile are saved in a single folder.

Referring to FIG. 22, an image 2201 as an original image is segmented into four tiles. The server 204 extracts only packet data 2202 from the image data in accordance with a request received from a user terminal, and sends that packet data 2202 to the user terminal. The user terminal prepares four folders 2203, 2204, 2205, and 2206 for respective tiles, and saves packet data files created based on the packet data received from the server 204 in corresponding folders.

The fourth embodiment is substantially the same as the first to third embodiments except for the processing contents in step S603 in the process (FIG. 6) for caching data received from the server 204 by the user terminal.

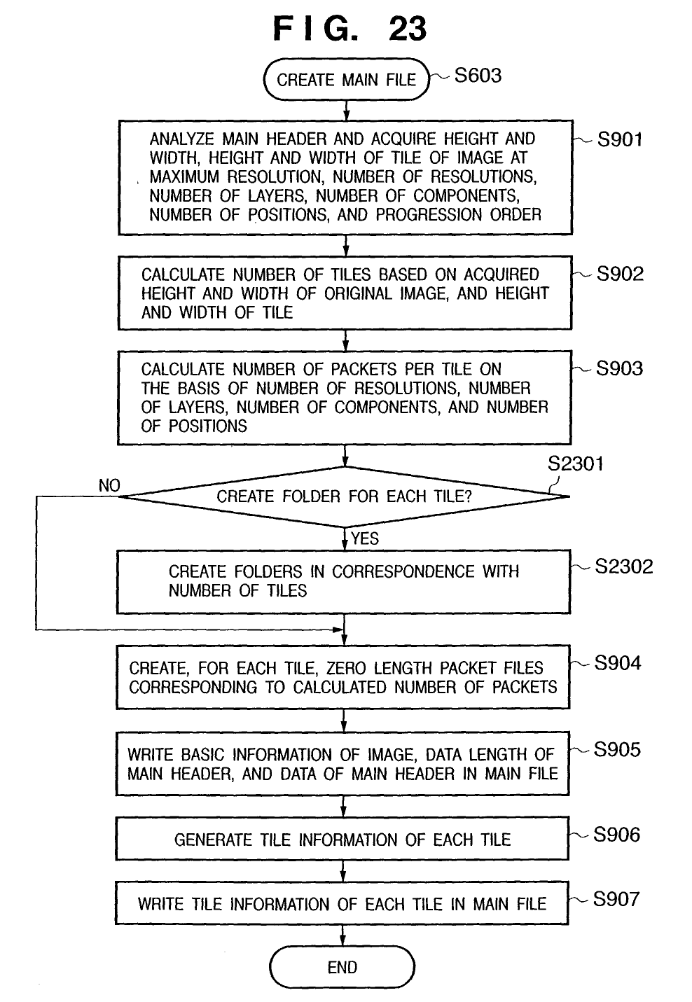

FIG. 23 is a flow chart showing the creation process (S603) of the main file 701. Since the processes in steps S901 to S903 and steps S904 and S907 are the same as those with the same step numbers in the first embodiment described with reference to FIG. 9, a description thereof will be omitted.

Whether or not a folder is created for each tile is determined in step S2301 to see if the number of packets obtained in step S903 exceeds a predetermined value. This checking process may be omitted in case of a system that always creates folders for respective tiles. For example, the number of files (threshold value) that can be processed within a single folder is determined based on information that represents the processing performance of the CPU 101 of the user terminal. If the number of packets has exceeded the threshold value, folders are created for respective tiles. Various methods for obtaining this threshold value may be used, but they are not related to the feature of the present application, and a description thereof will be omitted.

If it is determined in step S2301 that a folder is not created for each tile, the flow jumps to step S904. On the other hand, if it is determined in step S2301 that a folder is created for each tile, the flow advances to step S2302, and the user terminal creates folders in correspondence with the number of tiles. For example, if a file “image.jp2” is segmented into 50 tiles, folders with names “image_tile0000” to “image_tile0049” are created in the Temp folder under the C drive where the main file “image.iip2k” is stored.

In the fourth embodiment, zero length packet files corresponding to respective packets are created in respective folders. For this reason, the detailed sequence of tile basic information created in step S906 in FIG. 23 is the same as the tile basic information creation process (FIG. 10) in the first embodiment. In this case, pointer information that points to each packet file, i.e., the field 803 of the main file 701 may store a file name (e.g., “image_tile0000_pket0002.iip2k”) or may store “C:/Temp/image_tile0000/image_tile0000_pket0002.iip2k” as well as paths.

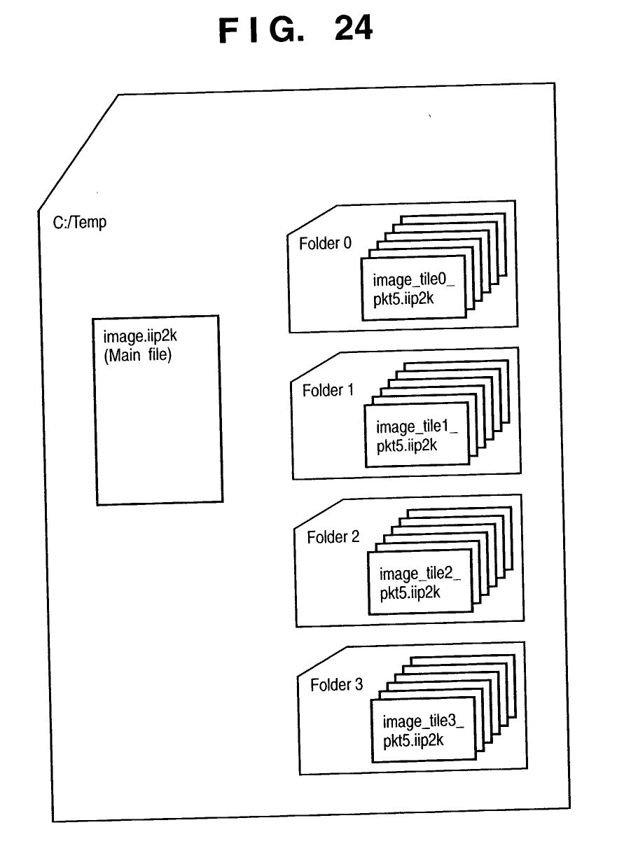

FIG. 24 shows the format of a cache file according to the fourth embodiment.

In the fourth embodiment, a method of creating one zero length packet file for each packet, i.e., the same method as in the first embodiment has been explained. Also, a method of creating only one zero length packet file as in the second embodiment, or a method of writing a value indicating a zero length packet (e.g., NULL) in the field 803 of the main file 701 without creating any zero length packet files as in the third embodiment may be used. When one zero length packet file is created, it can be created in, e.g., the Temp folder under the C drive, where the main file 701 is saved.

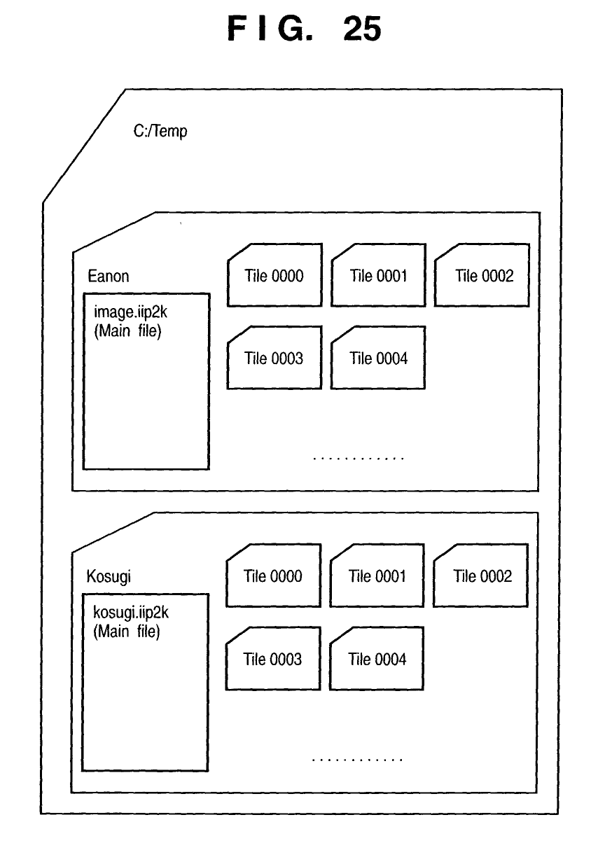

Furthermore, when a plurality of images may be handled at the user terminal, folders may be created for respective images. For example, image-dependent folders may be created in the Temp folder under the C drive, as shown in FIG. 25, and folders for respective tiles may be created in each of these folders. Under each image-dependent folder, the methods of creating cache files that have been explained in the first to fourth embodiments may be applied.

As described above, according to the fourth embodiment, a cache file is formed of a plurality of packet data. In such case, since a folder is created for each tile, the number of files created per folder can be limited. Therefore, processes such as creation, deletion, and the like of files, which depend on the OS (operating system) of the user terminal, can be made faster compared to other embodiments described above.

<Fifth Embodiment>

In the fifth embodiment, a method of reading out cache files created in the first, second, and fourth embodiments described above will be described in detail below with reference to the accompanying drawings.

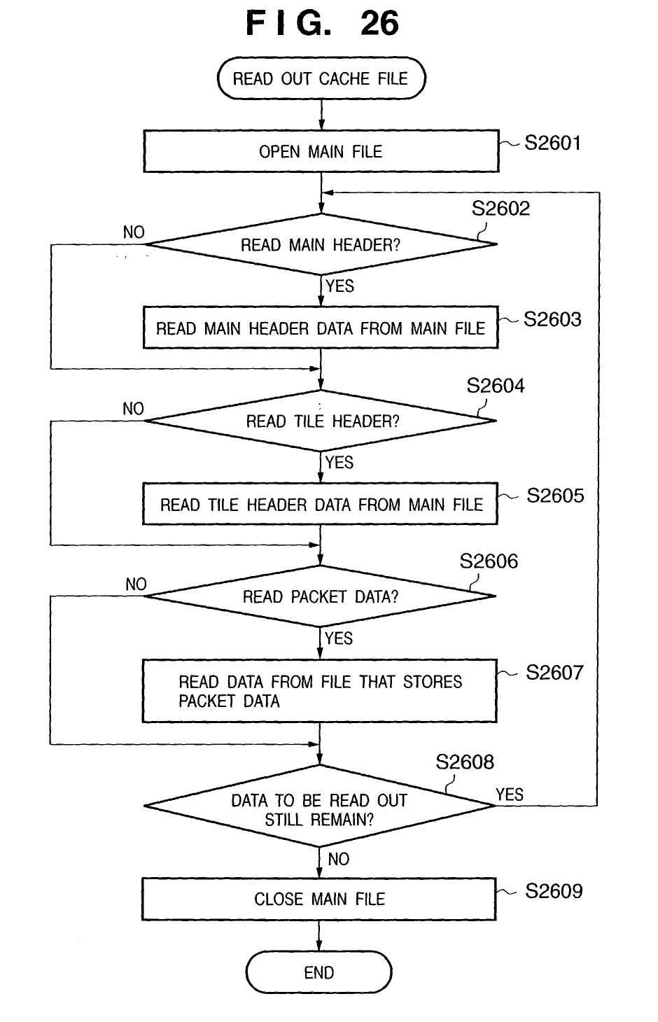

FIG. 26 is a flow chart showing a process for reading out a cache file in the user terminal, i.e., details of the process for reading out a cache file created in the user terminal in the first, second, and fourth embodiments.

In step S2601, the main file 701 created in step S603 in FIG. 6 is opened. For example, if a main file with a file name “image.iip2k” is created in a Temp folder under a C drive in correspondence with a file “image.jp2”, “C:/Temp/image.iip2k” is opened. The flow then advances to step S2602 to check if data to be read out is main header data. If NO in step S2602, the flow jumps to step S2604; otherwise, the flow advances to step S2603 to move a file pointer to the field 703 of the main file 701, where main header data acquired from the server 204 is directly written, and to read out the main header data. It is checked in step S2604 if data to be read out is tile header data. If YES in step S2604, the flow advances to step S2605; otherwise, the flow jumps to step S2606.

In step S2605, the file pointer is moved to a field of the main file 701, where the tile header 705 to be read out is described, and that tile header data is read.

For example, in step S2605 if the tile number starts from “0”, and the tile header to be read out is a header with tile number “1”, the file pointer is moved to the head of data 702 associated with tile data with tile number “1”, which is stored after the image information 706, main header data 703, and data 702 associated with tile data with tile number “0” are skipped from the head of the main file 701 in FIG. 7, and is further moved to the head of tile header data 705 next to management data 704 of tile data in that data, thus reading out data of the tile header 705.

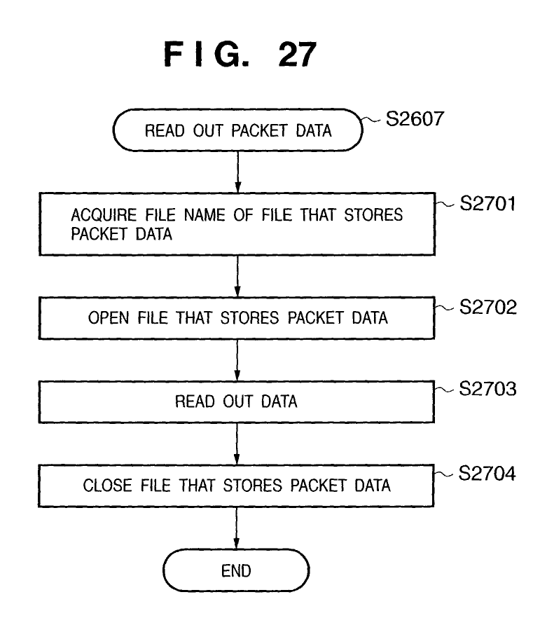

The flow advances to step S2606 to check if data to be read out is packet data. If YES in step S2606, the flow advances to step S2607; otherwise, the flow jumps to step S2608. In step S2607, data is read out from a packet file where the packet data to be read out is stored (note that details of step S2607 will be described later with reference to FIG. 27).

The flow advances to step S2608 to check if data to be read out still remain. If YES in step S2608, the flow returns to step S2602 to repeat the aforementioned process. On the other hand, if it is determined in step S2608 that all data to be read out have been read out, the flow advances to step S2609 to close the opened main file 701, thus ending this read process.

FIG. 27 is a flow chart showing the process for reading out packet data (step S2607) according to the fifth embodiment.

Referring to FIG. 27, a file name is acquired in accordance with information of the pointer 803 of a file that stores the packet data to be read out in step S2701. For example, when data with tile number “1” and packet number “0” is to be read out, the field 702 where tile information associated with tile number “1” is obtained from the main file 701, and is searched for management data 802 for packet data with packet number “0”. Then, the file name is acquired based on information of the pointer 803 of that packet management data 802 to a file that describes the packet data.

The flow advances to step S2702 to open a file with the file name acquired in step S2701. For example, if the file name acquired in step S2701 is that of a file “image_zero.iip2k” in the Temp folder under the C drive, the file “image_zero.iip2k” of that folder is opened. On the other hand, if the file name acquired in step S2701 is “C:/Temp/Tile0001/image_tile0000_pkt0000.iip2k”, a file “image_tile0000_pkt0000.iip2k” in a folder “Tile0001” in the Temp folder under the C drive is opened.

The flow advances to step S2703 to read out data in the file opened in step S2702. The flow advances to step S2704 to close the file opened in step S2702, thus ending the packet data read process.

As described above, in the aforementioned read method according to the fifth embodiment of the present invention described above, when the user terminal reads out packet data, a file pointed by information of the pointer 803 to that packet file, which is described in the main file 701, is opened, and data of that file is then read out.

According to the fifth embodiment, the cache file created in the first, second, and fourth embodiments can be efficiently read out.

<Sixth Embodiment>

In the first, second, and fourth embodiments, since zero length packets are created even for packet data that have not been received by the user terminal yet, all packet data are written in files.

However, in the third embodiment described above, since files are created only for received packets, those corresponding to non-received packets are not present in the user terminal. For this reason, the read method according to the fifth embodiment cannot read out some packet data. To solve this problem, the sixth embodiment will explain a method of reading out a cache file created in the third embodiment.

In the sixth embodiment, since the processing configuration in step S2607 is different from that in the cache file read process (FIG. 26) described in the fifth embodiment, this process will be mainly explained below.

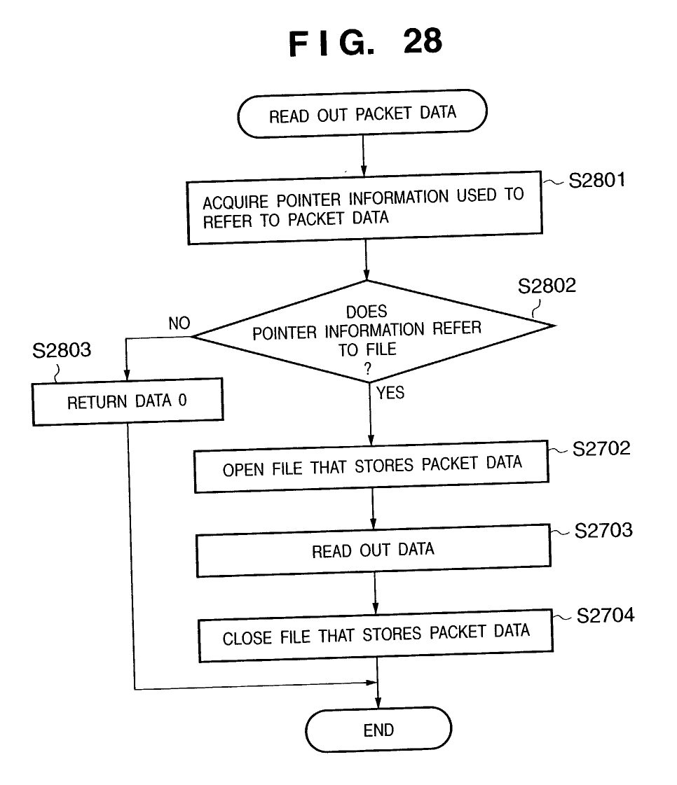

FIG. 28 is a flow chart showing the process for reading out packet data according to the sixth embodiment of the present invention. Since the processes in steps S2702 to S2704 are the same as those with the same step numbers in the fifth embodiment described with reference to FIG. 27, a description thereof will be omitted.

Referring to FIG. 28, information of the pointer 803 in the main file 701 to a packet to be read out is acquired in step S2801. The flow advances to step S2802 to check if the information of the pointer 803 acquired in step S2801 is a pointer to a packet data file. For example, if the acquired information is a file name “C:/Temp/image_tile0000_pkt2.iip2k”, it is determined that the acquired information is pointer information to a file; if the acquired information is NULL, it is determined that the information does not point to any file. If it is determined in step S2802 that the pointer information 803 points to a file, the flow advances to step S2702, and the subsequent processes are the same as those in the fifth embodiment.

On the other hand, if it is determined that the pointer 803 does not point to any file, the flow advances to step S2803. In this case, since no file corresponding to a packet to be read out is present, it is determined that the packet to be read out has not been received yet, and a 1-byte value “0” indicating a zero length packet is returned as readout information.

As described above, according to the sixth embodiment, a cache file created in the third embodiment can be efficiently read out.

Since the read method of the sixth embodiment described above is used when no zero length packet file is created for non-received data, even when a folder is created for each tile or image, as described in the fourth embodiment, this read method can be applied when no zero length packet file is created for non-received data.

<Seventh Embodiment>

In the first to sixth embodiments, each packet data is saved and managed in one cache file. However, a plurality of packets may be saved and managed in a single file. That is, images can be saved and managed using one cache file per image.

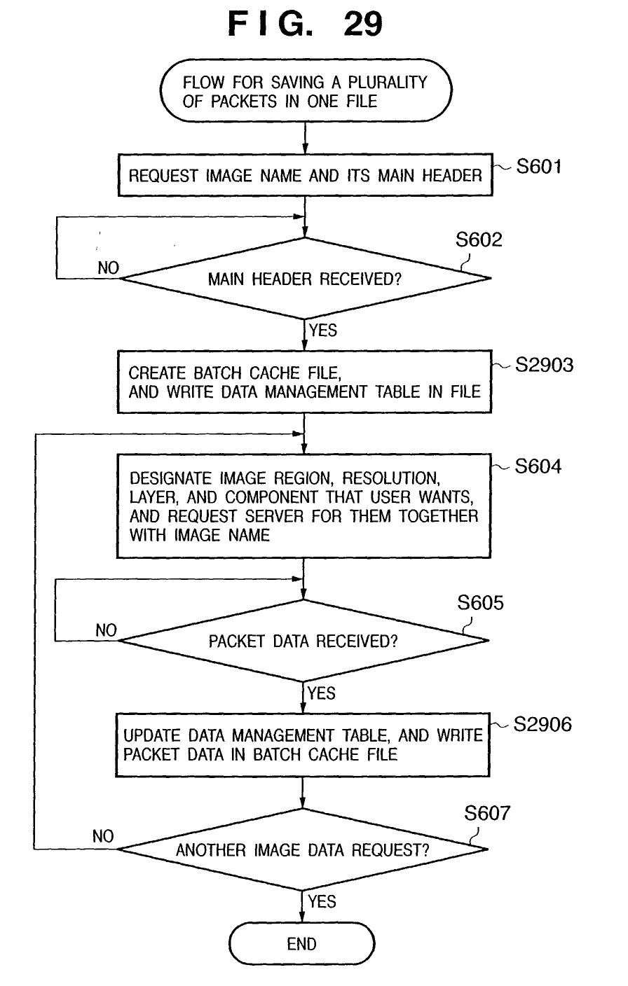

FIG. 29 is a flow chart showing a received data cache process in the user terminal (image processing apparatus: 201 or 202) according to the seventh embodiment of the present invention. Note that the same step numbers in FIG. 29 denote the same steps as those in FIG. 6.

In step S601, the user terminal requests the server 204 that stores a plurality of images for a required image name and the main header of that image data via the network 203 in step S601. In response to this request, packet data sent from the server 204 is received, and it is checked in step S602 if a main header is received. Upon receiving the main header, the flow advances to step S2903 to create information used to manage information of the entire image and cache data, as shown in FIG. 7, and a file (to be referred to as a batch cache file) that saves cache data itself on the basis of the received main header, and to write the main header acquired in step S602 in a field 703 of the batch cache file. The batch cache file created in this embodiment has substantially the same data format as the main file 701 created in the first to fourth embodiments (see FIG. 7 for the data format), except for the following two points.

(1) Actual cache data itself is written.

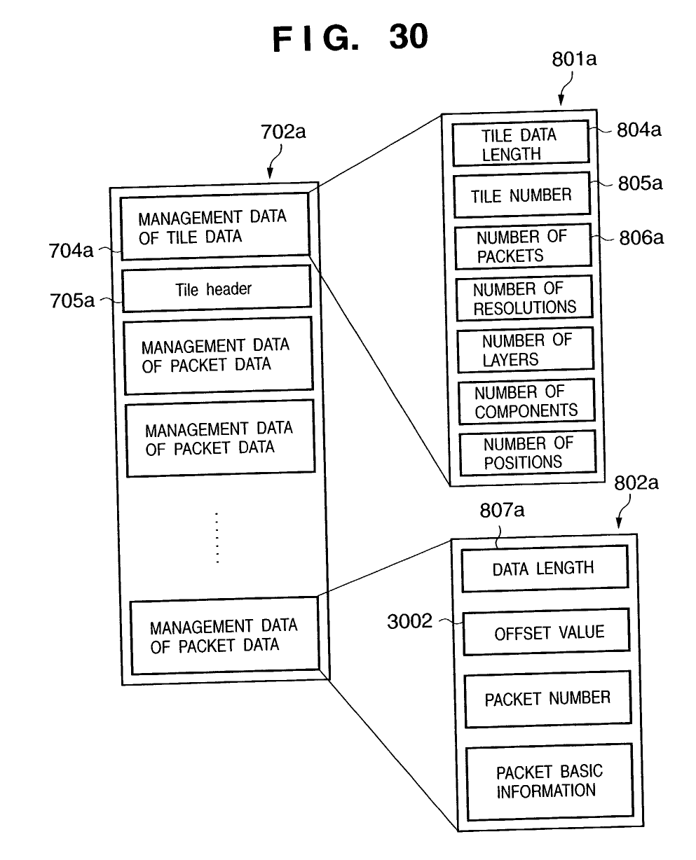

(2) The pointer 803 contained in the management data 802 of packet data in FIG. 8 is replaced by an offset value 3002 (FIG. 30).

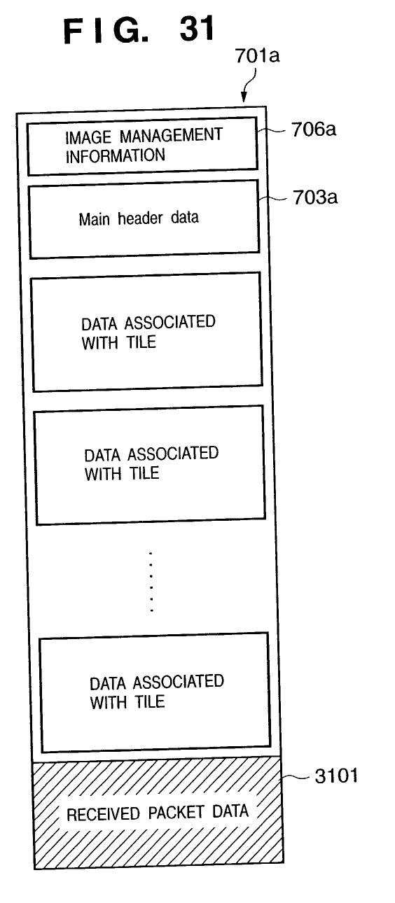

FIG. 30 shows the format of packet management data 802a in a field 702a (corresponding to the field 702 in FIG. 8) of a batch cache file 701a (FIG. 31) according to the seventh embodiment.

That is, upon receiving the main header in step S602, the flow advances to step S2903, and the user terminal creates a batch cache file 701a in a desired area of the secondary storage 103 (e.g., a Temp folder under the C drive) as a file with a file name in which the name of the original image is inserted at its head position. For example, if the user requests a file “image.jp2”, the user terminal creates a batch cache file with a name “image.iip2k” in a folder of the secondary storage 103.

The flow advances to step S604 to request the server 204 for the required image region, resolution, layer, and component according to user's selection operations via the network 203. Since user's selection operations in step S604 are not related to the gist of the cache method as the principal object of the present application, a description thereof will be omitted.

In response to this request, the server 204 sends an image portion designated by the user terminal to the user terminal for respective packets of JPEG2000. Upon receiving packet data in step S605, the flow advances to step S2906 to rewrite information used to manage cache data associated with the received packet data, and to append packet data in a field 3101 after the batch cache file 701a. The flow advances to step S607 to check if the user has requested another image data. If YES in step S607, the flow returns to step S604 to repeat the aforementioned operation; otherwise, the control returns.

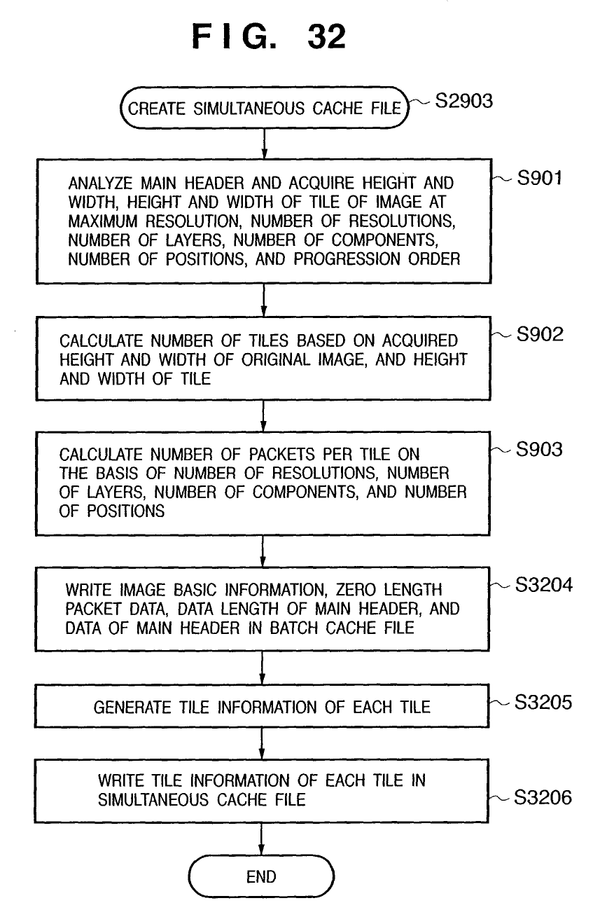

FIG. 32 is a flow chart for explaining the process for creating the batch cache file 701a in step S2903 in FIG. 29. Note that the same step numbers in FIG. 32 denote the same steps as those in the flow chart showing the main file creation process in FIG. 9.

The main header received from the server 204 is analyzed in step S901 to acquire the height and width of an original image, the height and width of a tile at a maximum resolution and the number of resolution levels, the number of layers, the number of components, the number of positions, and the progression order. The flow advances to step S902 to calculate the number of tiles on the basis of the height and width of the original image, and those of a tile at the maximum resolution. The flow advances to step S903 to calculate the number of packets contained per tile on the basis of the number of resolution levels, the number of layers, the number of components, and the number of positions acquired in step S901.

The flow then advances to step S3204 to write basic information of the original image such as the number of tiles, the number of resolution levels, the number of layers, the number of components, and the like, which are obtained in step S901 by analyzing the main header, zero length packet data, and the data length of the main header in a field 706a (FIG. 31) of the batch cache file 701a as image management information. The field 703a of this batch cache file 701a stores data of the received main header. The flow advances to step S3205 to create basic information of each tile in a field 702a of the batch cache file 701a, as shown in the right enlarged view of FIG. 30. The flow advances to step S3206 to write the basic information of each tile created in step S3205 in the batch cache file 701a, thus ending the batch cache file creation process.

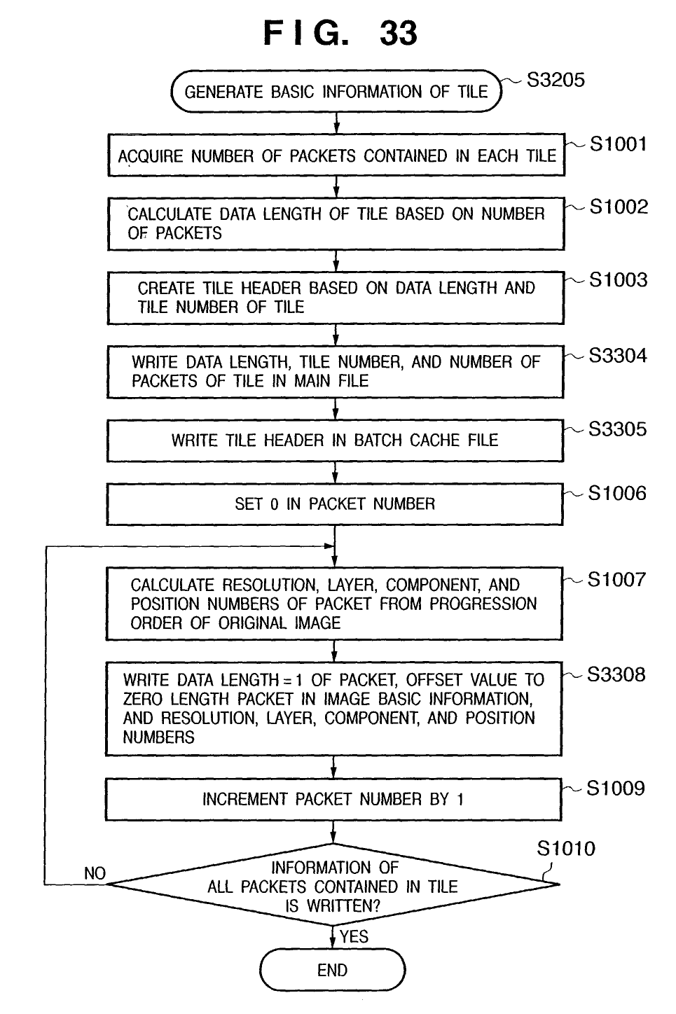

FIG. 33 is a flow chart showing the process for generating basic information of each tile in step S3205 in FIG. 32 according to the seventh embodiment, and the same step numbers in FIG. 33 denote common steps to those in the flow chart shown in FIG. 10. In step S3205, the operations in the flow chart shown in FIG. 33 are repeated in correspondence with the number of tiles in the order of tile numbers, thus creating fields 702a of the batch cache file 701a shown in FIG. 30.

Referring to FIG. 33, the number of packets contained per tile, which has already been calculated in step S903 in FIG. 32, is acquired in step S1001. At this time, the user terminal has not received any packet data from the server 204 yet, and all these non-received packets are processed as zero length packets. Hence, in step S1002, the data length of each tile is calculated by:

(length of tile header)+(number of packets contained in tile)×1 byte

For example, if a marker contained in the tile header is only an SOT marker, and one tile contains 36 packets, the data length of this tile is 14+1×36=50 [bytes].

The flow advances to step S1003 to create an SOT marker to be contained in the tile header in JPEG2000 on the basis of the tile number and the data length of a tile. FIGS. 11A and 11B show the format, data size and practical value of the SOT marker created for a tile which has tile number “0” and contains “36” packets.

The flow advances to step S3304 to write a data length 804a of a tile, tile number 805a, the number 806a of packets contained in the tile, and the number of resolutions, the number of layers, the number of components, and the like that the tile contains in management data 704a of tile data in the batch cache file 701a. The flow then advances to step S3305 to write the tile header in a field 705a of the batch cache file 701a. The flow advances to step S1006 to set “0” in the packet number, and processes in step S1007 and subsequent steps are repeated in the order of packet numbers.

In step S1007, the resolution level, layer, component, and position numbers corresponding to the packet number are specified in accordance with the progression order of the original image. The flow advances to step S3308 to write a data length=1 of the packet of interest, an offset value to zero length packet data written in the field 706a of the batch cache file 701a in step S3204 as the offset value of this packet data, and information required upon managing the packet of interest such as the resolution level, layer, component, and position numbers, and the like in a field 802a of the batch cache file 701a.

The flow advances to step S1009 to increment the packet number of the packet of interest by 1, and it is then checked in step S1010 if a series of processes starting from step S1007 are complete for all packets contained in that tile. If YES in step S1010, this operation ends. For example, when the number of packets is “36”, if the packet number after step S1009 is “36”, this process ends.

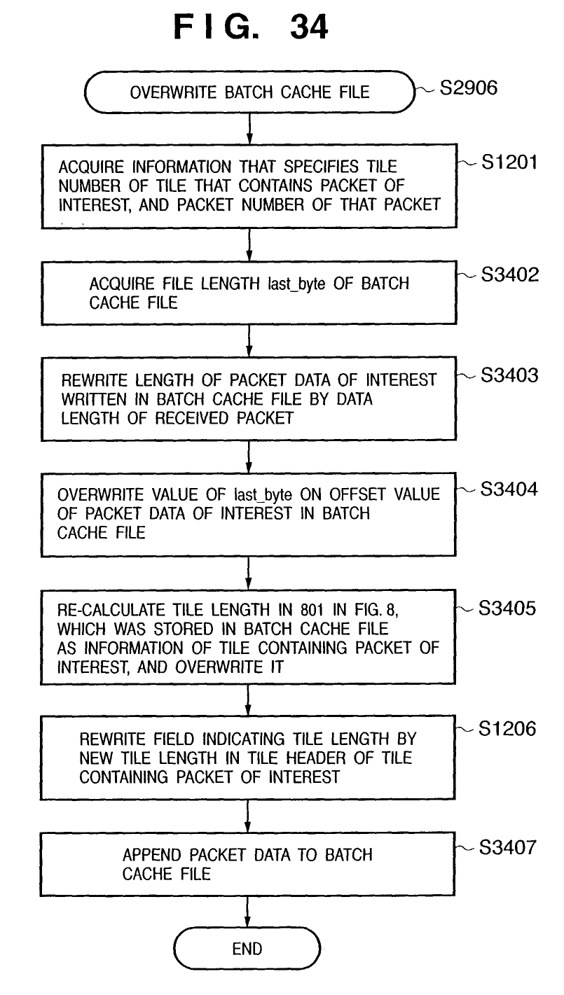

FIG. 34 is a flow chart showing the overwrite process of the batch cache file 701a in step S2906 in FIG. 29, and the same step numbers in FIG. 34 denote processing steps common to those in FIG. 12.

In step S1201, information that specifies the tile and packet numbers of a tile that contains a packet to be written in the cache is acquired. The flow advances to step S3402 to acquire the file length (last_byte) of the batch cache file 701a. The flow advances to step S3403 to rewrite the length of this packet data written in the batch cache file 701a by the data length of the received packet, i.e., a packet to be written in the cache. The flow advances to step S3404 to overwrite the value of last_byte acquired in step S3402 on the offset value 3002 of this packet data. The flow advances to step S3405 to re-calculate the data length 804a of the tile in the field 801a in FIG. 30, which was written in the batch cache file 701a, and overwrite it as information of the tile that contains this packet. For example, if the data length of the packet to be written in the cache is 128 bytes, the data length of a non-received packet is calculated as 1 byte as the length of a zero length packet in this batch cache file 701a. Hence, the data length to be re-calculated of the tile is (128−1)=127 [bytes]. By adding this value to the already stored data length 804a of the tile, a new data length of the tile is calculated. The flow advances to step S1206, and a field that describes the tile length is rewritten by the value re-calculated in step S3405, as in FIG. 12. The flow advances to step S3407 to append packet data 3101 to the batch cache file 701a. That is, this packet data is written after the end of the batch cache file 701a, thus ending this routine.

When the aforementioned cache method according to the seventh embodiment is used, since only one cache file need only be managed per image, data management can be prevented from being complicated.

<Eighth Embodiment>

In the eighth embodiment, the method of reading out the batch cache file 701a created in the seventh embodiment will be described in detail below with reference to the accompanying drawings.

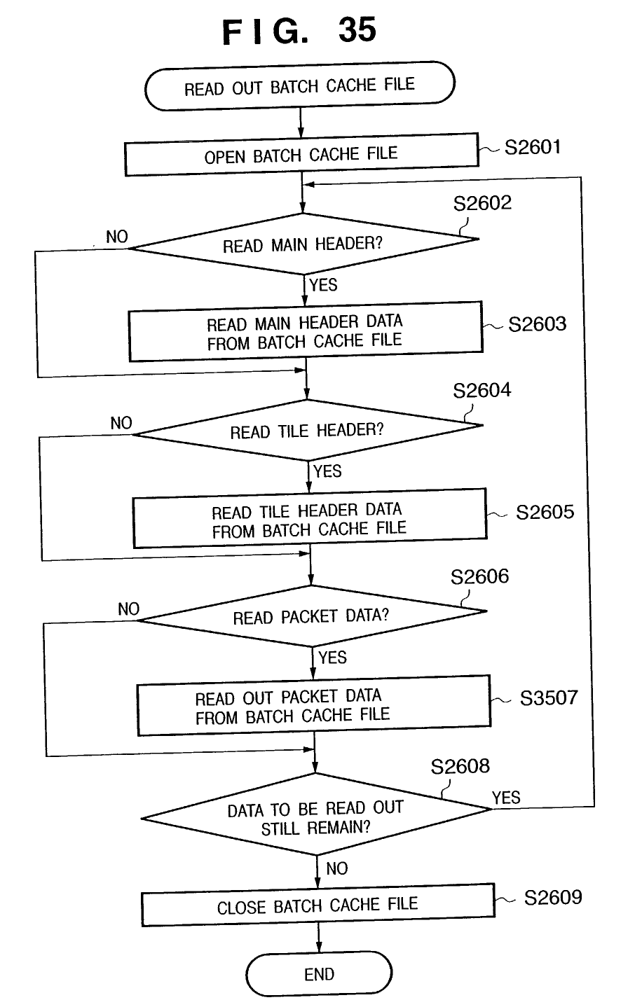

FIG. 35 is a flow chart showing a process for reading out the batch cache file 701a in the user terminal according to the eighth embodiment of the present invention, i.e., details of the process for reading out a cache file created on the user terminal in the seventh embodiment described above. Note that the same step numbers in FIG. 35 denote the same steps as those in FIG. 26 above. The difference from FIG. 26 lies in that a cache file 701a, which is called a batch cache file in the seventh embodiment and caches table data and packet data together, is read in place of a batch cache file which is called a main file in FIG. 26 and stores only a table. Hence, in step S3507 in FIG. 35 packet data is read out from the batch cache file opened in step S2601 unlike in FIG. 26.

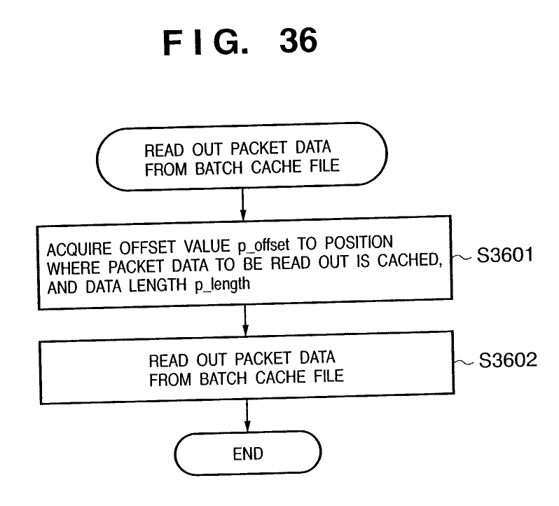

FIG. 36 is a flow chart showing the process for reading out packet data in step S3507 in FIG. 35 according to the eighth embodiment.

In step S3601, a data length (p_length) of packet data and an offset value (p_offset) from the head of the batch cache file 701a to that of actually cached packet data are respectively acquired from a data length 807a and offset value 3002 of cache management data 802a shown in FIG. 30 in association with packet data to be read out by this routine. The flow advances to step S3602 to read out target packet data on the basis of the offset value (p_offset) and data length (p_length) acquired in step S3601, thus ending this read process.

That is, a pointer is moved from the head of the batch cache file 701a to a byte position indicated by the offset value (p_offset), and data having the number of bytes indicated by the data length (p_length) is read out from that pointer position, thus acquiring target packet data.

When the cache write method described in the seventh embodiment and the cache read method according to the eighth embodiment are used, if data corresponding to non-received packet data is actually written in the cache file 701, that packet data can be read out by identical operations without providing any conditional branch step of checking if the packet of interest is non-received packet data upon reading out data.

<Ninth Embodiment>

In the seventh embodiment, a zero length packet is inserted at the position of non-received packet data, and is written in the field 706a of the batch cache file 701a. By contrast, in the ninth embodiment, a value indicating a non-received packet (“NULL”) is written in a field 3002 of the packet data management data 802a in FIG. 30, where an offset value is written, in place of actually writing zero length packet data corresponding to a non-received packet in the batch cache file 701a.

Upon reading out the cache file 701a created in this way, the method of reading out packet data in step S3507 in FIG. 35 is different from the eighth embodiment.

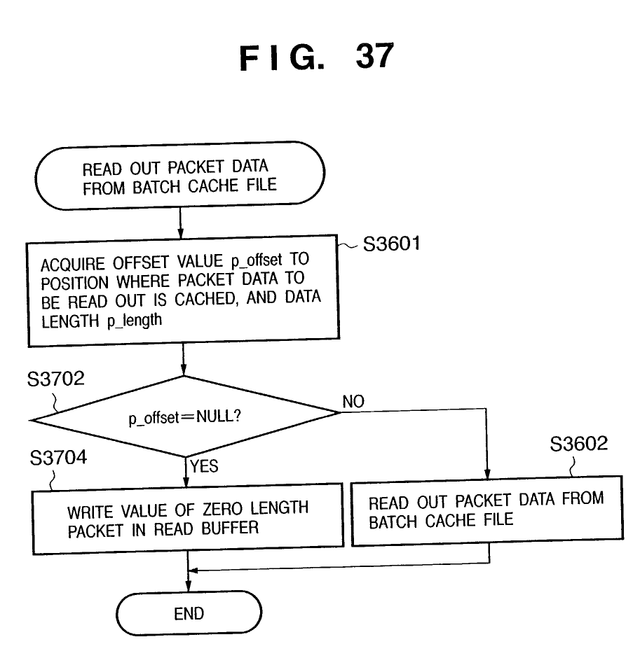

FIG. 37 is a flow chart showing a process for reading out packet data according to the ninth embodiment of the present invention, and the same step numbers in FIG. 37 denote steps common to those in FIG. 36 above. The flow chart in FIG. 37 is different from that in FIG. 36 after the conditional branch step S3702 in FIG. 37.

It is checked in step S3702 if the offset value (p_offset) acquired in step S3601 is “NULL”. If YES in step S3702, the flow advances to step S3704; otherwise, the flow advances to step S3602. That is, if the offset value (p_offset) is NULL, it is determined the packet of interest is not received, and the flow advances to step S3704; otherwise, it is determined that the packet of interest is already cached packet, and the flow advances to step S3602. In the process in step S3602, packet data is read out by the same operation as in FIG. 36.

On the other hand, in step S3704 since data is not received yet, and is not present in the cache file 701a, zero length packet data is written in a read buffer in place of the non-received data.

According to the ninth embodiment, since a file seek process for reading out non-received data is skipped, data can be read out at high speed.

In the above description, all cache files or cache file folders are created in the Temp folder under the C drive. The locations where the cache files or cache folders are created are not limited to this, and may be changed as needed according to an environmental variable.

According to the aforementioned image data cache read/write methods (i.e., the cache file creation method of the first to fourth embodiments, the cache file read method according to the fifth and sixth embodiments, the cache file creation method according to the seventh and ninth embodiments, and the cache file read method according to the eighth and ninth embodiments), tiled encoded data can be easily managed at the user terminal 201 (or 202), and by sequentially reading the created cache file, the cached data can be read out as one encoded data complying with JPEG2000 encoded data format even when not all tiled encoded data of an image to be displayed are received in practice. For this reason, if a JPEG2000 decoder of normal specifications is prepared in the user terminal, that user terminal can display an image having a resolution of user's choice.

Even when encoded data for one image are not completely stored in the cache file, the encoded data loaded onto the primary storage 102 of the user terminal as a result of the sequential read perfectly complies with the JPEG2000 encoded data format, and no special JPEG2000 decoder for this cache file is required.

Furthermore, even when encoded data is added during transfer of tiled data from the server 204, it can be added quickly by replacing a corresponding packet data file.

<10th Embodiment>

The 10th to 13th embodiments to be described below relate to a method of reformatting segmented image data received via a network to obtain a single image file and, more particularly, to a method which can be practiced on a client that receives JPEG2000 encoded data complying with ISO/IEC-15444 as segments of image encoded data or segment encoded data of the Internet imaging protocol (IIP) or the like, and caches these segment encoded data by a unique method, and also to a method of generating one encoded data file complying with JPEG2000 from cache data of segment encoded data, which are received by the client, in accordance with a display request issued by an application program on the client.

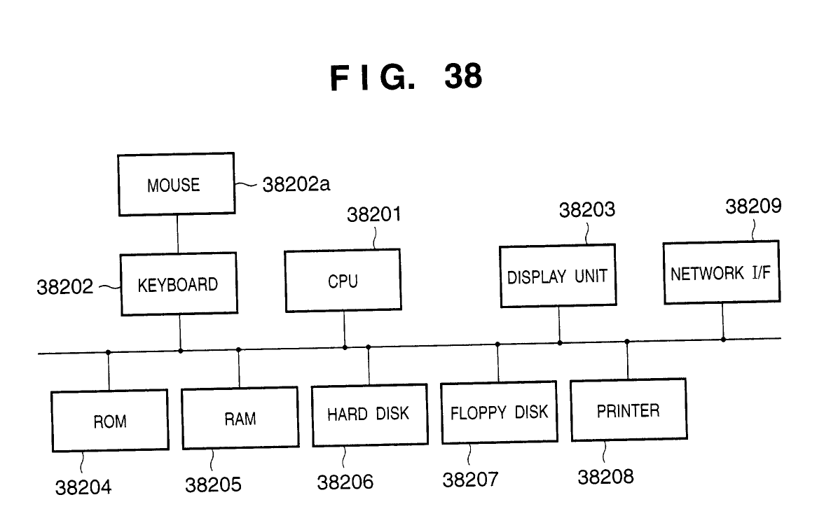

In these embodiments, a plurality of computers are connected to a network represented by the Internet, as shown in FIG. 2 above, and each of user terminals and server has an arrangement shown in FIG. 38.

FIG. 38 is a block diagram showing the hardware arrangement of the server 204, the user terminal 201 or 202, or the like.

Referring to FIG. 38, reference numeral 38201 denotes a CPU (corresponding to the CPU 101 in FIG. 1), which makes, e.g., the control of the entire apparatus. Reference numeral 38202 denotes a keyboard which is used to input information such as various data, commands, and the like to this apparatus together with a mouse 38202a. These devices correspond to the input device 104 in FIG. 1. Reference numeral 38203 denotes a display unit, which comprises, e.g., a CRT, liquid crystal display, or the like. Reference numeral 38204 denotes a ROM; and 38205, a RAM. The ROM 38204 and RAM 38205 form a storage unit (primary storage 102) in this apparatus, and store programs to be executed by this apparatus, data used by this apparatus, and the like. Reference numeral 38206 denotes a hard disk device; and numeral 38207 denotes a floppy disk device. These devices 38206 and 38207 form an external storage device (secondary storage 103). Reference numeral 38208 denotes a printer. The printer 38208 and display unit 38203 correspond to the output device 105 shown in FIG. 1. Reference numeral 38209 denotes a network interface (corresponding to the communication interface 106) that controls the network. The apparatus shown in FIG. 38 can access network resources such as a server and the like connected to the network 100 such as the Internet or the like (in case of a client) or can send encoded image and document data in response to a request from the client (in case of a server) via the network interface 38209.

In this embodiment, an already generated JPEG2000 file is managed by the server 204. On the other hand, the user terminal 201 or 202 requests the server 204 for only a required portion of the JPEG200 file corresponding to a request from a client such as an image display application or the like using the IIP for JPEG2000, receives tiled encoded data sent in response to that request, and caches the received tiled encoded data in its hard disk 38206 or the like. A process for converting the tiled JPEG2000 encoded data cached in the hard disk 38206 or the like into encoded data complying with JPEG2000, which is to be passed to a JPEG2000 decoder, will be explained below.

The user of the user terminal opens a given home page using, e.g., a Windows machine, and clicks a link to a JPEG2000 written on that page to acquire and cache the JPEG2000 image as tiled data required to display that image with an image size and resolution according to the purpose of the user terminal. It is assumed that one bit-stream is generated from these cached data, and is decoded to display an image.

If JPEG2000 encoded data is used, a client can receive only data of a required part from the server 204 without acquiring all image data stored in the server 204. As a unit of received data in the user terminal, a packet of JPEG2000 or a code-block as an encoding unit smaller than the packet may be used. In this embodiment, a packet is assumed as a data unit that the client receives from the server. The concept of a request and response for each packet has been explained previously with reference to FIG. 5.

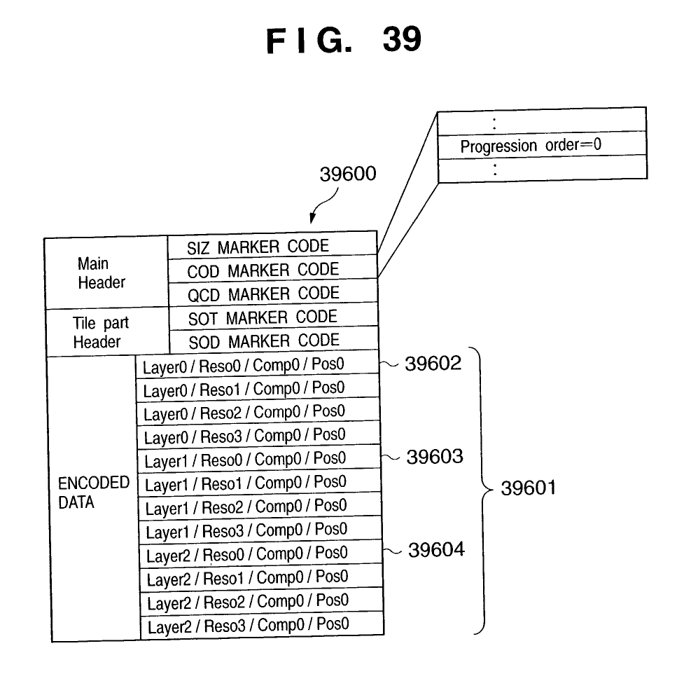

FIG. 39 shows an example of a JPEG2000 file managed by the server 204 used in this embodiment.

Referring to FIG. 39, reference numeral 39600 denotes an example of file encoded by SNR progression, in which three different layers “0” to “2”, four different resolution levels “0” to “3”, and one each component and position are available. Reference numeral 39601 denotes the order of packets in this case. Assume that the image size at a maximum resolution of JPEG2000 managed by the server 204 is 1024×1024 pixels for the sake of simplicity. Hence, since four different resolution levels are available, the image sizes at respective resolution levels are 1024×1024, 512×512, 256×256, and 128×128 pixels.

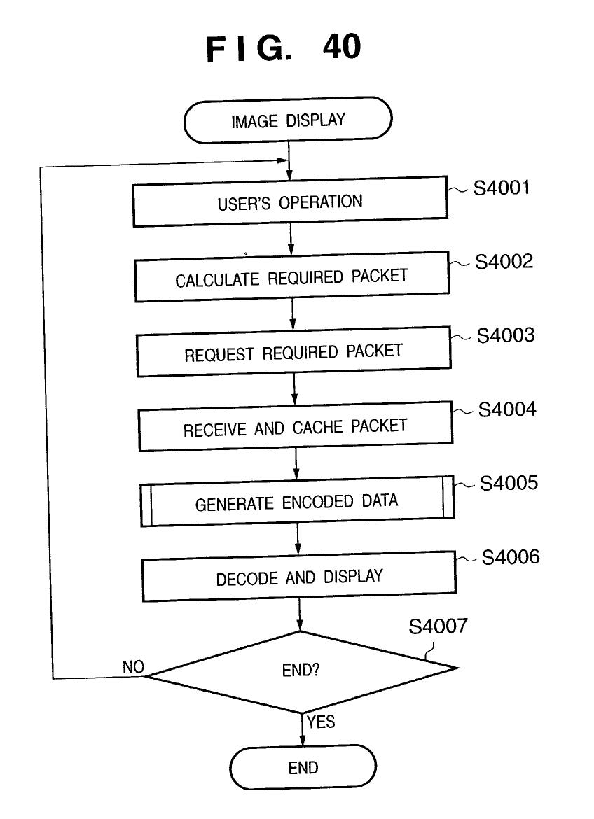

FIG. 40 is a flow chart showing an outline of a process executed by an application that runs on the user terminal 201 (which will represent terminals hereinafter). This flow chart shows an image display process after a JPEG2000 application is launched on the user terminal 201, and a JPEG2000 file to be displayed is designated by another means.

In step S4001, the user makes an operation for display. At the time of launching the application, an image size that can fall within the opened window size may be calculated. The flow advances to step S4002 to calculate packets newly required as a result of the operation in step S4001. The flow advances to step S4003 to request the server 204 for newly required packet data on the basis of the calculation result in step S4002. The flow advance to step S4004 to receive all requested packet data, which are sent from the server 204 in response to the request, and to cache them in the user terminal 201. The flow advances to step S4005 to convert encoded data managed in the cache format into the format of a JPEG2000 encoded data file. The flow advances to step S4006 to decode the JPEG2000 encoded data obtained in step S4005, and to display the decoded data. The flow advances to step S4007. If the user requests to quit the application, the application quits; if the user issues another display request, the flow returns to step S4001 to repeat the aforementioned process.

The practical processing contents of the 10th embodiment will be described below.

Assume that the window display size of the application is 128×128 pixels immediately after the application is launched on the user terminal 201, and a case will be examined below wherein image data with a size that falls within this window display size is to be displayed. Furthermore, in this case, required packets calculated in step S4002 in FIG. 40 display data with an image size corresponding to the lowest resolution level and maximum SNR. In such case, three packets “Layer0/Reso0/Comp0/Pos0” 39602, “Layer1/Reso0/Comp0/Pos0” 39603, and “Layer2/Reso0/Comp0/Pos0” 39604 shown in FIG. 39 are required. Therefore, a program on the server 204 executes a process for extracting these three packets. As can be seen from FIG. 39, if packets are stored based on SNR progression, three each packets, which are not required in the current decode process, are stored between the packets 39602 and 39603, and between packets 39603 and 39604.

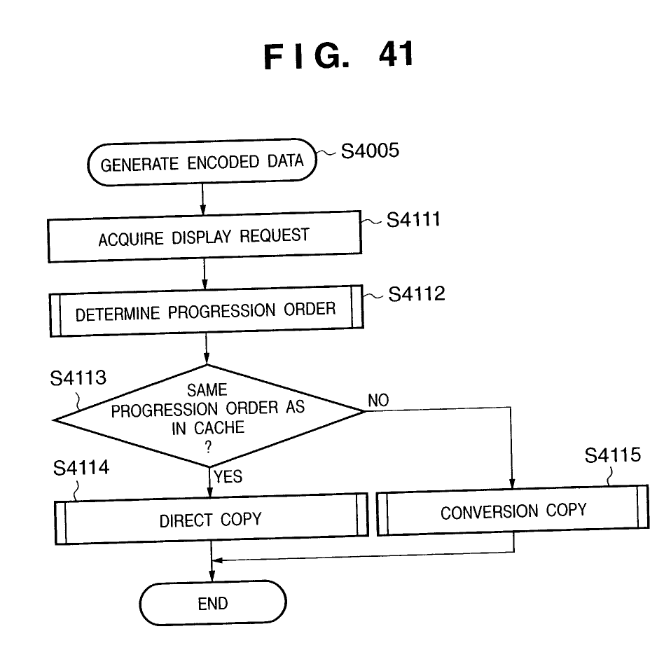

The encoded data generation process in step S4005 in FIG. 40 will be described in detail below with reference to the flow charts in FIGS. 41 to 44.

FIG. 41 is a flow chart showing the “encoded data generation” process in step S4005 in FIG. 40.

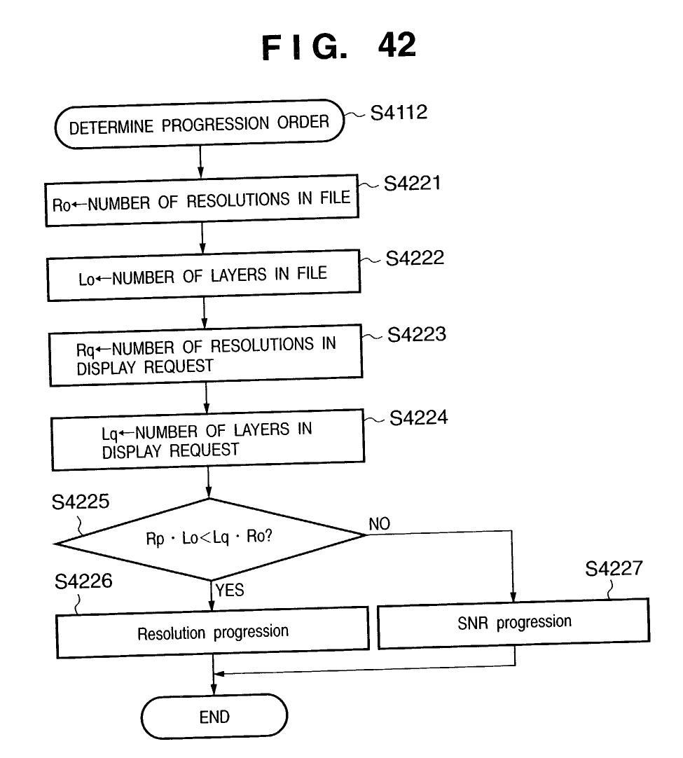

In step S4111, the display request that the user of the user terminal 201 issued to the application is acquired. The flow advances to step S4112 to determine the progression order that the JPEG2000 decoder can process at high speed, on the basis of the display request acquired in step S4111. This determination process will be described later with reference to the flow chart shown in FIG. 42. The flow advances to step S4113 to check if the progression order determined in step S4112 is the same as that of the cached packets. If YES in step S4113, the flow advances to step S4114; otherwise, the flow advances to step S4115. In step S4114, since the progression order is the same as that of the cached packets, the packets are copied according to the format in the cache to generate a JPEG2000 encoded data file. On the other hand, a JPEG2000 encoded data file is generated while converting the progression order.

The “progression order determination” process in step S4112 in FIG. 41 will be explained below with reference to FIG. 42.

In steps S4221 and S4222, the number of resolution levels and the number of layers in the JPEG2000 encoded data file currently requested for the server 204 are acquired in variables Ro and Lo, respectively. In steps S4223 and S4224, the number of resolution levels and the number of layers for display are acquired in variables Rq and Lq on the basis of the display request which is currently designated by the user and is acquired in step S4111. Note that these variables Ro, Lo, Rq, and Lq are set in the aforementioned RAM 38205. The flow then advances to step S4225 to calculate Rq×Lo and Lq×Ro on the basis of the values of the variables, and to compare these products. If Rq×Lo<Lq×Ro, the flow advances to step S4226 to determine “resolution progression”; otherwise, the flow advances to step S4227 to determine “SNR progression”.

This process will be explained below using an example. Ro=4 (resolution levels 0 to 3) and Lo=3 (layers 0 to 2) in steps S4221 and S4222, and Lq=1 (since 128×128) and Lq=3 (layers 0 to 2) in steps S4223 and S4224. As a result, Rq×Lo=3, and Lq×Ro=12, and Rq×Lo<Lq×Ro holds. Hence, the flow advances to step S4226 to select “resolution progression”. In this manner, it is determined in step S4113 in FIG. 41 that the determined progression order is different from that of the cached packets, and the flow advances to the conversion copy process in step S4115.

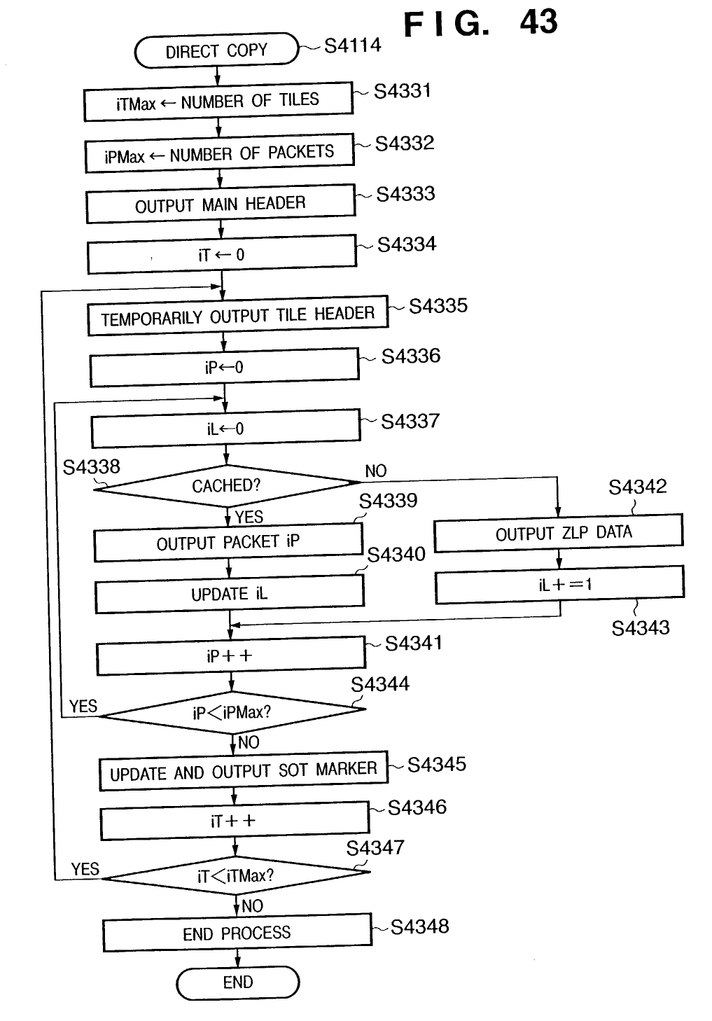

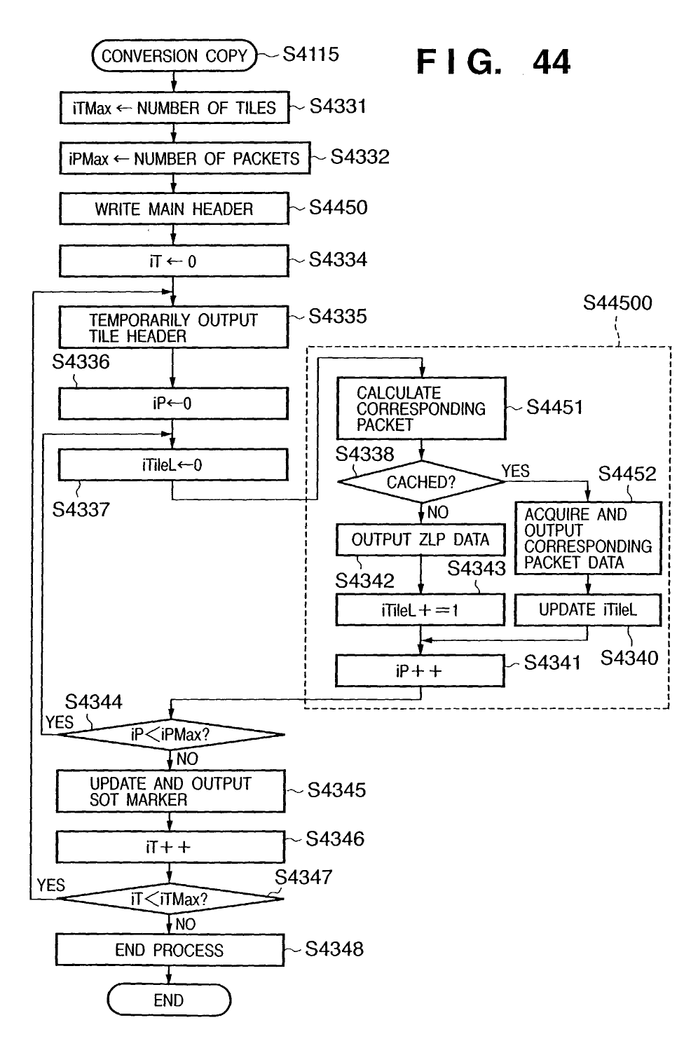

FIG. 43 is a flow chart showing details of the “direct copy” process in step S4114 in FIG. 41, and FIG. 44 is a flow chart showing details of the “conversion copy” process in step S4115 in FIG. 41.

The “direct copy” process will be described first with reference to FIG. 43.

In steps S4331 and S4332, the number of tiles and the number of packets are acquired and stored in variables iTMax and iPMax, respectively. The flow advances to step S4333 to output a main header of JPEG2000. The flow advances to step S4334 to reset an internal variable iT to “0”. Note that these variables are set in the RAM 38205, as described above.

The flow advances to step S4335 to generate and temporarily output a tile header (SOT marker code). In steps S4336 and S4337, a variable iP used to count the number of packets, and a variable iL used to count the number of bytes of packet data are respectively reset to “0”. The flow advances to step S4338 to check if data of a packet indicated by the variable iP is cached. If the data of interest is cached, i.e., it has already been transferred from the server 204, the flow advances to step S4339; otherwise, the flow advances to step S4342. Packet data indicated by the variable iP is output in step S4339, and the number of bytes of the output packet data is added to the variable iL in step S4340. On the other hand, if the data of interest is not cached, the flow advances to step S4342 to output ZLP (zero length packet) data. The flow advances to step S4343 to add the number of bytes of ZLP data, i.e., “1”, to the variable iL.

After step S4340 or S4343 is executed in this way, the flow advances to step S4341 to increment the variable iP (+1), and the flow then advances to step S4344 to compare the variable iP with the variable iPMax. Step S4343 checks if processes for all packets in a tile are complete. If packets to be processed still remain, the flow returns to step S4337 to repeat the aforementioned process; otherwise, the flow advances to step S4345 to update the value of a field that manages the number of data of the entire tile from the variable iL. Then, the number of data of the entire tile in the output SOT marker code is output. The flow advances to step S4346 to increment the variable iT (+1) that counts the number of tiles. The flow advances to step S4347 to check if the value of the variable iT has reached the maximum number of tiles, i.e., if all tiles have been processed. If NO in step S4347, the flow returns to step S4335 to repeat the aforementioned process; otherwise, the flow advances to step S4348 to execute a process for completing JPEG2000 encoded data. In this case, an EOC marker code and the like are output.

FIG. 44 is a flow chart showing the “conversion copy” process in step S4115 in FIG. 41, in which JPEG2000 encoded data is generated while changing the progression order, and the same step numbers in FIG. 44 denote the same processes as in FIG. 43. Hence, only processes different from those in FIG. 43 will be explained below.

After the number of tiles and the number of packets are stored in the variables iTMax and iPMax in steps S4331 and S4332, main header data indicating the progression order, which is determined in step S4112 in FIG. 41 and allows the JPEG2000 decoder to execute a high-speed process, is generated and output in step S4450. More specifically, a field value of “progression order” in a COD marker code 39600 in FIG. 39 is changed. In FIG. 44, processes bounded by a dotted line 44500 are different from those in the flow chart shown in FIG. 43. That is, in step S4451 a packet to be output in the order indicated by the variable iP is calculated on the basis of “progression order” changed in step S4450. After that, the packet data is actually acquired and output in step S4452. Since the remaining processes are the same as those in FIG. 43, a description thereof will be omitted.

A practical example of the process according to this embodiment will be explained below.

In case of the 10th embodiment, since “resolution progression” is selected as the progression order of output encoded data, and the progression order in the cache is “SNR progression”, the “conversion copy” process shown in FIG. 44 is selected.

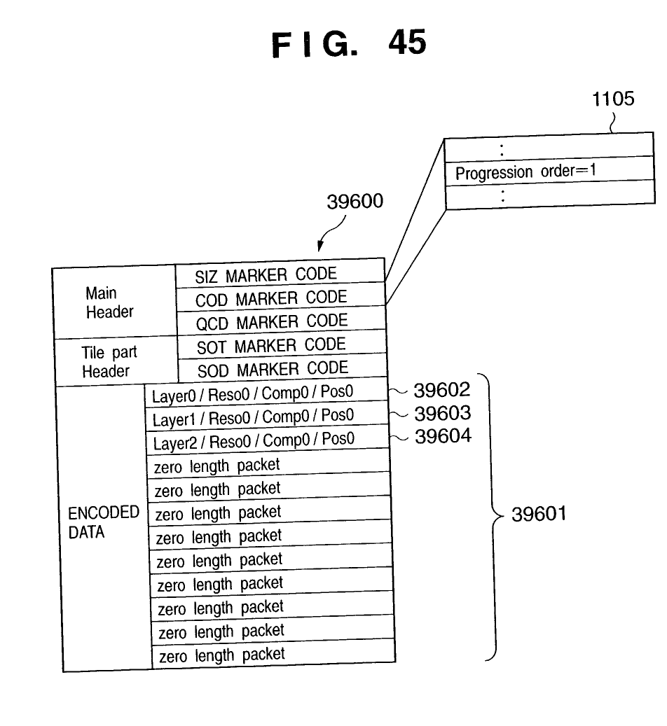

In steps S4331 and S4332, since the number of tiles is “1”, the variable iTMax=1 is set, and since there are 12 packets, as shown in FIG. 39, the variable iPMax=12 is set. In step S4450, the contents of the progression order field in the COD marker code are changed to “1” indicating “SNR progression”, and are written in the main header, as indicated by 1105 in FIG. 45. The flow advances to step S4334 to reset the variable iT to “0”, and a tile header is temporarily output in step S4335. After that, the variable iP and a variable iTileL are reset to “0” in steps S4336 and S4337. In step S4451, the cache is searched for a packet to be output in the order indicated by the variable iP. Initially, since the value of the variable iP is “0”, a packet to be output first, i.e., packet data “Layer0/Reso0/Comp0/Pos0” is searched for. The flow advances to step S4338 to check if that packet data has been cached. Since that data has already been cached in the current loop, the flow advances to step S4452 to actually acquire and output packet data “Layer0/Reso0/Comp0/Pos0”. The flow advances to step S4340 to add the number of bytes of the output packet to the variable iTileL. The flow advances to step S4341 to increment the variable iP used to count the number of packets (+1), and the variables iP and iPMax are compared in step S4344. Since iP<iPMax holds currently, i.e., since not all packets are read, the flow returns to step S4337. If the value of the variable iP is “1” and “2”, the same processes as described above are executed; if the value of the variable iP falls within the range from “31” to “11”, since it is determined in step S4338 that data is not cached, the flow advances from step S4338 to step S4342 to output ZLP data, and the variable iTileL is incremented in step S4343. After the process in step S4341, if the value of the variable iP has reached “12”, since it is determined in step S4344 that iP<iPMax does not hold, the flow advances to step S4345 to calculate the number of bytes of the tile based on the variable iTileL so as to change the corresponding position in the SOT marker. The flow then advances to step S4346 to increment the value of the variable iT, and it is checked in step S4347 if all tiles have been processed. In this embodiment, since the number of tiles is 1, the flow advances to step S4348 to execute an end process.

In this way, JPEG2000 encoded data shown in FIG. 45 is completed.

Another case will be examined below wherein an image with a maximum resolution and minimum SNR is to be displayed. More specifically, an image based on packets to up resolution level “3” and layer “1” is displayed. In this case, required packets calculated in step S4003 (FIG. 40) are: “Layer0/Reso0/Comp0/Pos0”, “Layer0/Reso1/Comp0/Pos0”, “Layer0/Reso2/Comp0/Pos0”, “Layer0/Reso3/Comp0/Pos0”, “Layer1/Reso0/Comp0/Pos0”, “Layer1/Reso1/Comp0/Pos0”, “Layer1/Reso2/Comp0/Pos0”, “Layer1/Reso3/Comp0/Pos0”, and these eight packets are required in an actual decode process. The encoded data generation process (FIG. 40) in step S4005 in such case will be explained below.

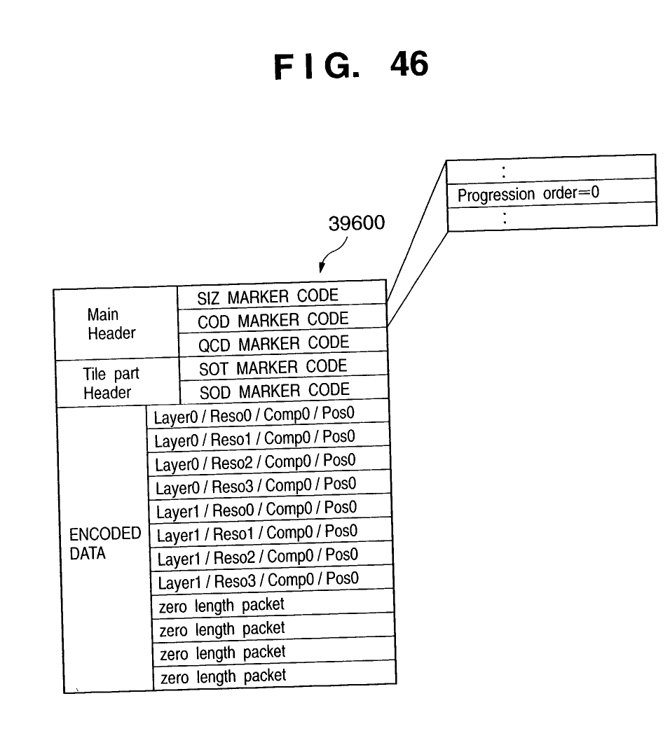

In this case, Ro=4 and Lo=3 in steps S4221 and S4222 in FIG. 42, and Rq=4 and Lq=2 in steps S4223 and S4224. Hence, since Rq×Lo=12 and Lq×Ro=8 in step S4225, Rq×Lo<Lq×Ro does not hold, and the flow advances to step S4227 to select “SNR progression”. As a result, it is determined in step S4113 that the selected progression order is the same as that of the cache, and the flow advances to step S4114, i.e., the “direct copy” process. After that, the process shown in the flow chart in FIG. 43 is executed to generate JPEG2000 encoded data shown in FIG. 46.

In this manner, independently of the display request input from the user terminal 201, conversion can be made so that packet data to be actually processed by the decoder are encoded data which are possibly contiguous from the head of encoded data, and a high-speed decode process can be done.

<11th Embodiment>

In the 10th embodiment, the progression order in the main header is changed. In the 11th embodiment, only a tile required for display is changed.

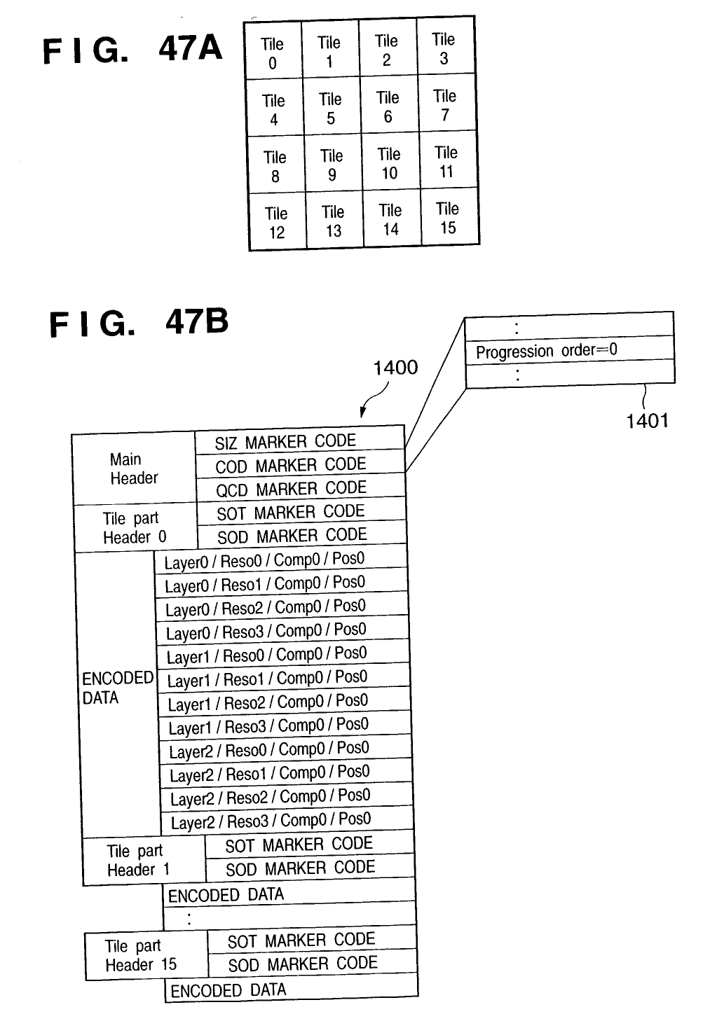

FIG. 47A shows a case wherein single image data is segmented into 16 tiles.

FIG. 47B shows an example of encoded data managed by the server 204. All tile data of this encoded data are stored based on “SNR progression” as in the 10th embodiment above. In the 11th embodiment, a case will be explained below wherein packet data of resolution level “0” and layer “0” of all tiles are sent and displayed so as to display an entire image first, and the resolution of only four tiles, i.e., tiles 5, 6, 9, and 10, is increased to display an image. Assume that the resolution level requested in this case is “1”. Reference numeral 1400 in FIG. 47B denotes an example of a JPEG2000 encoded data file, which is encoded under such condition, and is stored in the server 204. As shown in FIG. 47B, all tiles are encoded under the same condition, and information indicating the progression order is described in a COD marker in the main header, as denoted by 1401.

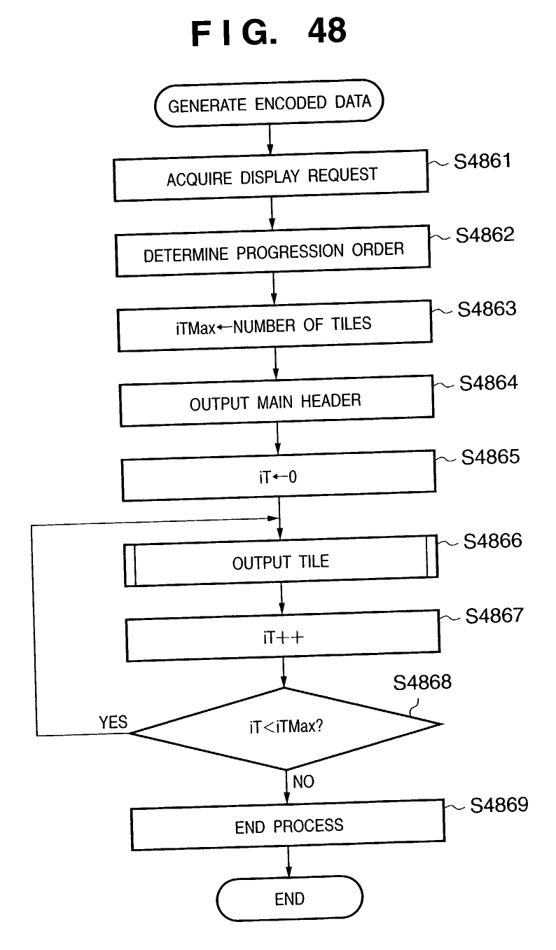

A case will be examined below wherein encoded data required to display an entire image, i.e., packet data of resolution level “0” and layer “2” of all tiles are requested for this file, and the image is then displayed by increasing the resolution of only tiles 5, 6, 9, and 10 in FIG. 47A. In this case, a case will be explained below with reference to FIG. 48 and subsequent figures wherein an image based on only packets of resolution level “1” and layer “2” of tiles 5, 6, 9, and 10 is to be displayed.

FIG. 48 is a flow chart showing an encoded data generation process according to the 11th embodiment of the present invention.

In step S4861, a display request is acquired from an application program on the user terminal 201. At this time, information of tiles to be displayed is also acquired unlike in the 10th embodiment described above. The flow advances to step S4862 to determine the progression order that allows the JPEG 2000 decoder to execute a high-speed process on the basis of the display request acquired in step S4861, as in step S4112 described above. In steps S4863 to S4865, the number of tiles is acquired and stored in a variable iTMax, the JPEG2000 main header is output, and an internal variable iT is reset to “0”, as in steps S4332 to S4334 above. The flow advances to step S4866 to output tile data, and the variable iT used to increment the number of tiles is incremented by+1 in step S4867. It is then checked if all tiles have been processed. If NO in step S4868, the flow returns to step S4866; otherwise, an end process is executed in step S4869, thus ending this process.

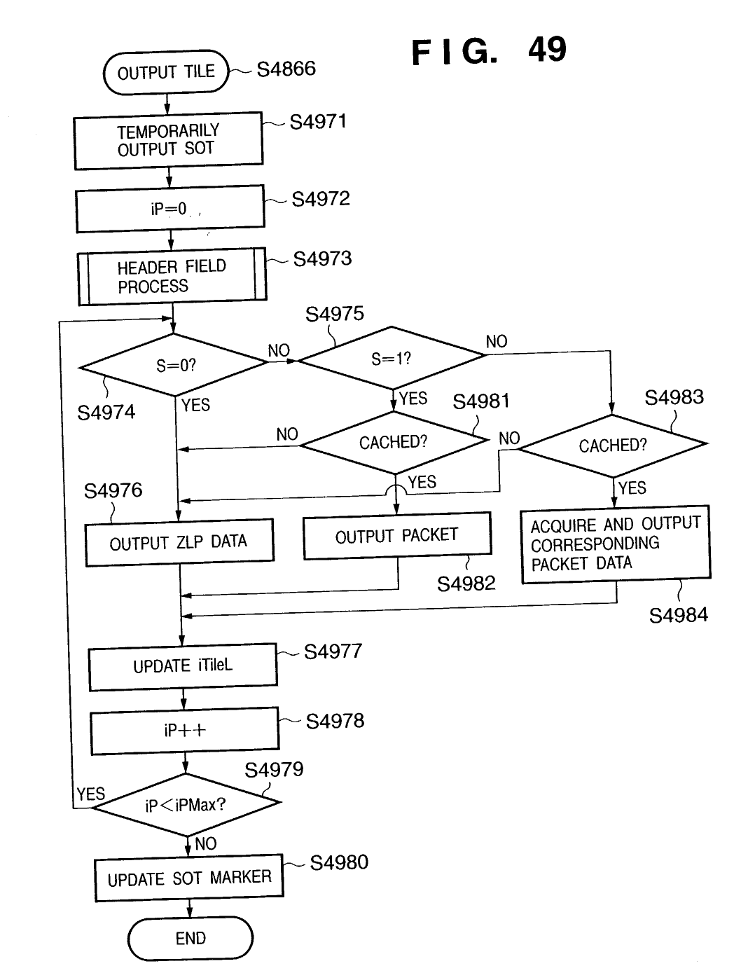

FIG. 49 is a flow chart showing the tile output process in step S4866 in FIG. 48.

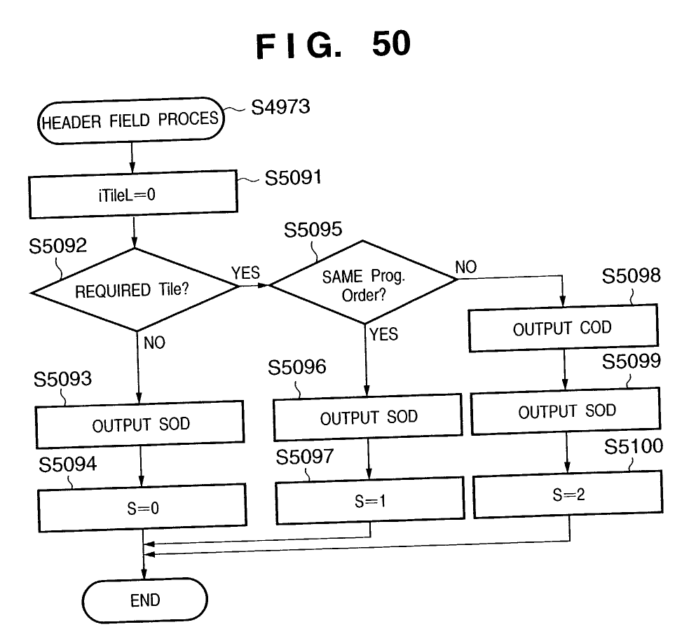

Referring to FIG. 49, only an SOT marker of the tile header is output in step S4971. Since the number of bytes of the SOT marker is not determined at this time, the SOT marker is temporarily output, as in the 10th embodiment. The flow advances to step S4972 to reset a variable iP used to count the number of packets to “0”, and a tile header field is processed in step S4973. This process will be described later with reference to the flow chart in FIG. 50.

The flow advances to step S4974 to select one of three processes depending on the value of a variable S set in step S4973. In this case, if S=0 in step S4974, the flow advances to step S4976 to replace all packet data by ZLP data. On the other hand, if S≠0 in step S4974, the flow advances to step S4975 to see if S=1. If S=1, i.e., the progression order output in the main header matches that of the tile of interest, the flow advances to step S4981 to check if packet data of interest is cached. If YES in step S4981, the flow advances to step S4982 to output the cached packet data in the order that packets are managed in the cache. If NO in step S4981, the flow advances to step S4976 to output ZLP data.

On the other hand, if S≠1 in step S4975, i.e., if the progression orders do not match, the flow advances to step S4983 to see if packet data of interest is cached. If YES in step S4983, the flow advances to step S4984 to acquire and output the packet data of interest from the cache. On the other hand, if NO in step S4983, the flow advances to step S4976 to output ZLP data. Other processes are the same as those in the 10th embodiment.

The header field process in step S4973 in FIG. 49 will be described below with reference to the flow chart in FIG. 50.

In step S5091, an initial value “0” is set in a variable iTileL used to count the number of tiles. The flow advances to step S5092 to check if the currently processed tile is one of those required in decoding, which are acquired in step S4861 in FIG. 48. If it is determined in step S5092 that the currently processed tile is not required in decoding, the flow advances to step S5093.

On the other hand, if the currently processed tile is required in decoding, the flow advances to step S5095 to check if progression orders match. In this checking process, it is checked if the progression order determined in step S4862 in FIG. 48 matches that in the main header processed in step S4864 in FIG. 48. If the two progression orders match, the flow advances to step S5096; otherwise, the flow advances to step S5098 to output a COD marker. This COD marker contains a field used to describe the progression order of this tile, and the value indicating the progression order determined in step S4862 in FIG. 48 is written in this field. After that, the flow advances to step S5099 to output an SOD marker. In this flow chart, the processes in steps S5093, S5096, and S5099 are the same. After that, the value of the variable S is determined in step S5094, S5097, or S5100 depending on the corresponding state.

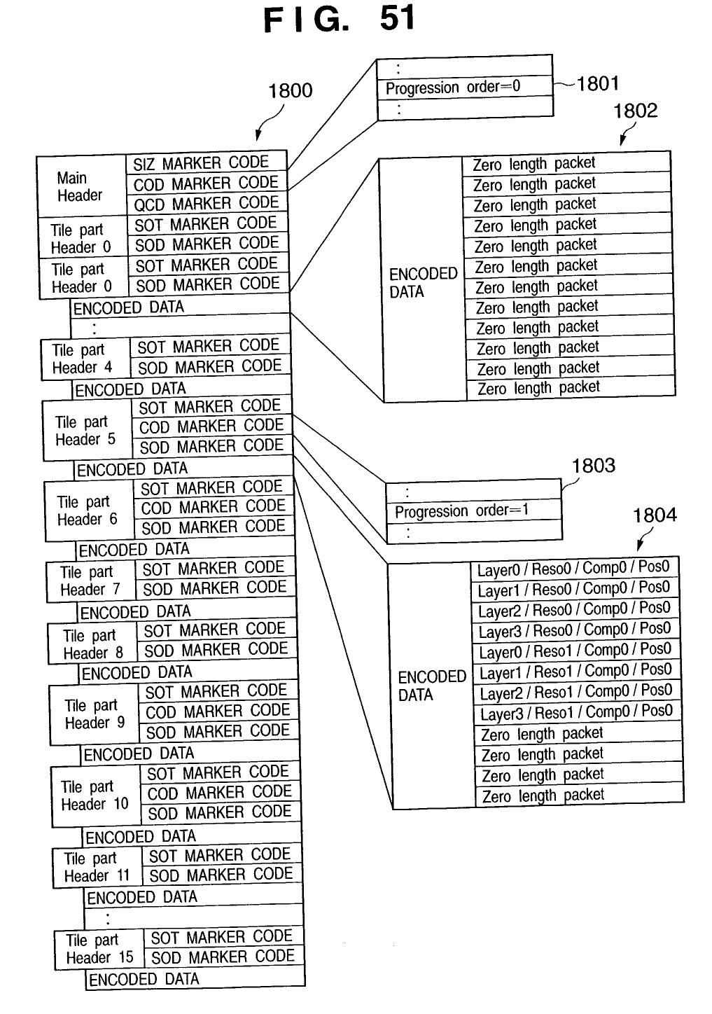

FIG. 51 shows an example of encoded data which is output when the encoded data 1400 shown in FIG. 47B has undergone the process of the 11th embodiment in practice.

Referring to FIG. 51, reference numeral 1800 denotes entire output encoded data; and numeral 1801 denotes the state of a COD marker code in the main header. The progression order in the main header indicated by 1801 has the same value as that in the file stored in the server 204. Tile data other than tiles 5, 6, 9, and 10 have values indicated by 1802. That is, all these tiles have ZLP data as those which are not related to the current decode and display processes. As data of tiles 5, 6, 9, and 10, a COD marker code is output first in each tile header, as indicated by 1803, and the value indicating the “progression order” is set in a field indicating the progression order in the COD marker. This is for the following reason. That is, since Rq×Lo=2×3=6 and Lq×Ro=3×4=12 based on the current display request, and it is determined in step S4225 in FIG. 42 that Rq×Lo<Lq×Ro, the flow advances to step S4226 to determine “resolution progression”. Reference numeral 1804 denotes actual data of tile 5.

In this manner, only a tile which requires a change in progression order undergoes the change process, and a faster conversion process can be done. Note that this decode process can be made at high speed as in the 10th embodiment described above.

As described above, using the file creation method according to the 11th embodiment, when tiled data of JPEG2000 encoded data sent using IIP are cached, and JPEG2000 encoded data that a normal JPEG2000 decoder can process is generated from this cache file, the JPEG2000 encoded data can be rebuilt in the progression order optimal to the current decode and display process, and an extra data process in the decode process can be omitted, thus allowing a high-speed decode process.

When a region to be decoded and displayed is designated using a tile, since the tile required in that decode and display processes can be processed, a high-speed process can be achieved. Furthermore, a complicated display method in which a display method is changed for each tile can be coped with.

<12th Embodiment>

The 12th embodiment of the present invention will be described below. In the 12th embodiment, the hardware arrangement is the same as that in the above embodiments. The 12th embodiment will also explain a case wherein data required for a user's display request are received for respective packets, and are displayed.

[Method of Selecting Write Data for Each Tile]

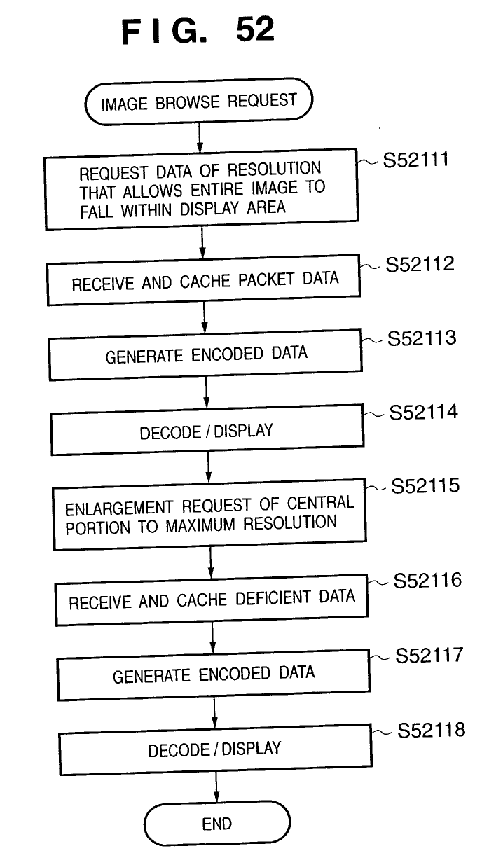

FIG. 52 is a flow chart showing a process according to the 12th embodiment of the present invention.

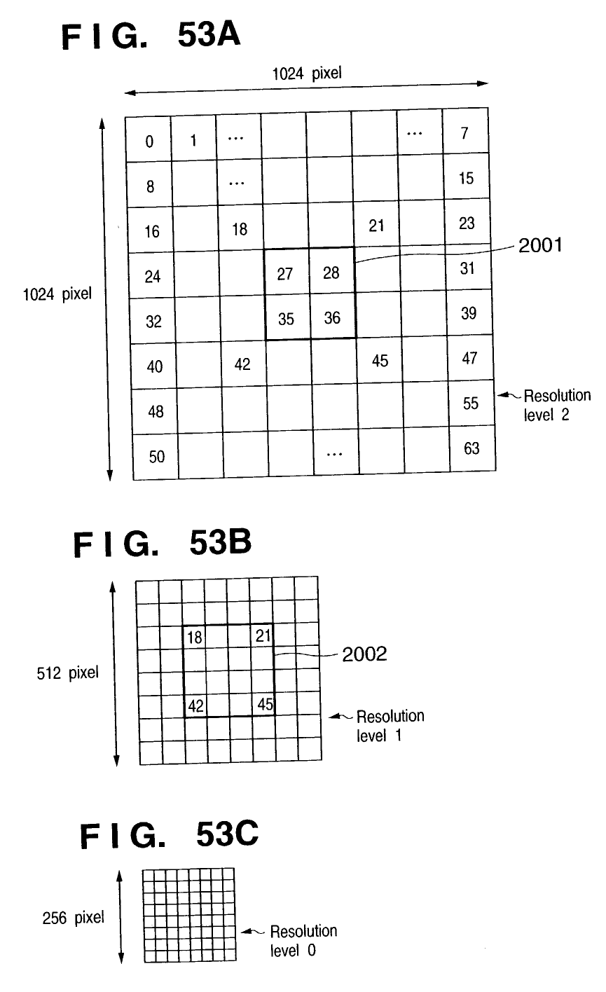

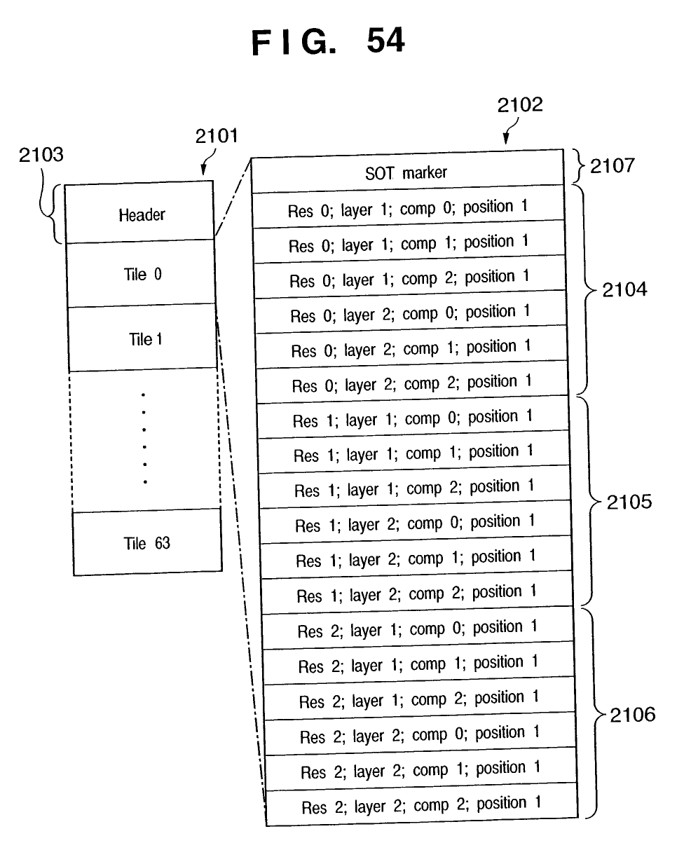

In step S52111, the user of the user terminal 201 requests the server 204 for data of a resolution that allows the entire image to fall within the display area. For example, assume that an original image (abc.jp2) is stored in the server 204. Also, assume that this image (abc.jp2) has a size of 1024×1024 (pixels) at a maximum resolution, and is segmented into 8×8=64 tiles, each of which has the number of components=“3” and the number of resolution levels=“2”, i.e., has three components in the image size direction, and is divided into two layers. Respective tiles are assigned sequence numbers in turn from the upper left tile, as shown in FIG. 53A. At this time, a JPEG2000 bit-stream in the server 204 has a format, as indicated by 2101 in FIG. 54.

If the JPEG2000 bit-stream in server 204 has an order of data complying with resolution scalability, packets are arranged in each tile, as indicated by 2102 in FIG. 54. Furthermore, if the display area on the user terminal 201 is 256×256 (pixels), the user terminal 201 requests header data 2103 of the image “abc.jp2” and packets of all tiles that form resolution “0”, i.e., packet data indicated by 2104 in FIG. 54 of respective tiles, in step S52111. That is, the user terminal requests 2 (layers)×3 (components)×64 (tiles)×1 (resolution)=384 (packets). The flow then advances to step S52112 to cache received packet data. That is, the header data and 384 (packet) data sent in response to the request are cached. The flow advances to step S52113 to generate JPEG2000 compatible encoded data according to a display image requested in step S52111 using the already received header data 2101 and packet data of the cached data. The flow advances to step S52114 to decode and display the encoded data generated in step S52113.

The flow then advances to step S52115, and the user issues a request to enlarge a given interesting portion of the image to a maximum resolution. For example, deficient data required upon displaying a region 2002 (FIG. 53B) of the central portion of resolution level 2 are requested. That is, in JPEG2000, since each resolution is formed by differential data, packet data that form resolution levels 1 and 2 of tiles 27, 28, 35, and 36 are requested. More specifically, 2 (layers)×3 (components)×4 (tiles)×2 (resolution levels)=48 (packets) indicated by packet data 2105 and 2106 (FIG. 54) of those of tiles 27, 28, 35, and 36 are requested. The flow advances to step S52116 to receive and cache deficient data. That is, 48 packet data requested in step S52115 are received and cached.

The flow advances to step S52117 to generate JPEG2000 compatible encoded data according to a display image requested in step S52115 using the data already received and cached in steps S52112 and S52116. The flow then advances to step S52118 to decode and display the data generated in step S52117. That is, a region 2001 of resolution level 2 in FIG. 53A is displayed.

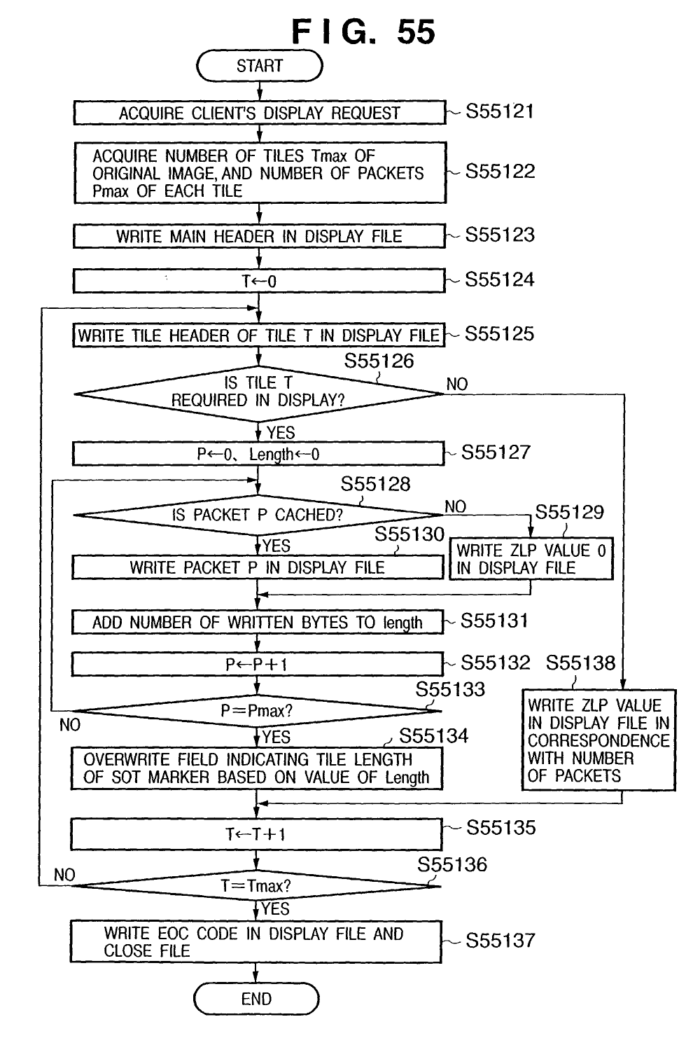

The encoded data generation operation in steps S52113 and S52117 will be described below with reference to the flow chart in FIG. 55.

In step S55121, tile numbers required in display are recognized so as to detect a display pattern of a client's request. For example, in case of step S52116, information indicating that the tile numbers required in display are 27, 28, 35, and 36 is acquired from the display request in step S52115. In step S55122, the number of tiles Tmax and the number of packets Pmax which form each tile of the original image in the server 204 are acquired. These data may be obtained by analyzing the JPEG2000 main header already received from the server 204, or by issuing an inquiry to the server 204.

The flow advances to step S55123 to directly write the main header received from the server 204 in a display file, i.e., a file in which encoded data to be passed to the decoder are written. In step S55124, “0” is set in a variable counter T used to count tile numbers to reset that counter. In step S55125, the tile header of tile T is written in the display file. Note that the tile length depends on the number of bytes of packet data contained in this tile. For this reason, an accurate tile length cannot be determined at that time. Hence, an SOT marker used when all packets are zero length packets (ZLPs) of “0”s is written. The data length of this tile is calculated by (length of tile header)+(the number of packets contained in tile)×1 (byte). For example, if an SOT marker alone is contained in the tile header and 18 packets are contained in one tile, since the ZLP length is 1 byte, the data length of this tile is 14+1×18=32 (bytes).

An example of the format of the SOT marker formed for a tile having tile number “0” and containing “18” packets is as shown in FIGS. 11A and 11B above.

It is checked in step S55126 if a tile having the tile number indicated by the counter T is included in the tile numbers required in display, which are acquired in step S55121. If NO in step S55126, i.e., if the tile of interest is not required in display, the flow advances to step S55138; otherwise, i.e., if the tile of interest is required in display, the flow advances to step S55127. For example, if tile numbers 27, 28, 35, and 36 are acquired as those required in display in step S55121, these four values are compared with the value of the counter T, and if one of these values matches the counter value, the flow advances to step S55127; otherwise, the flow advances to step S55138.

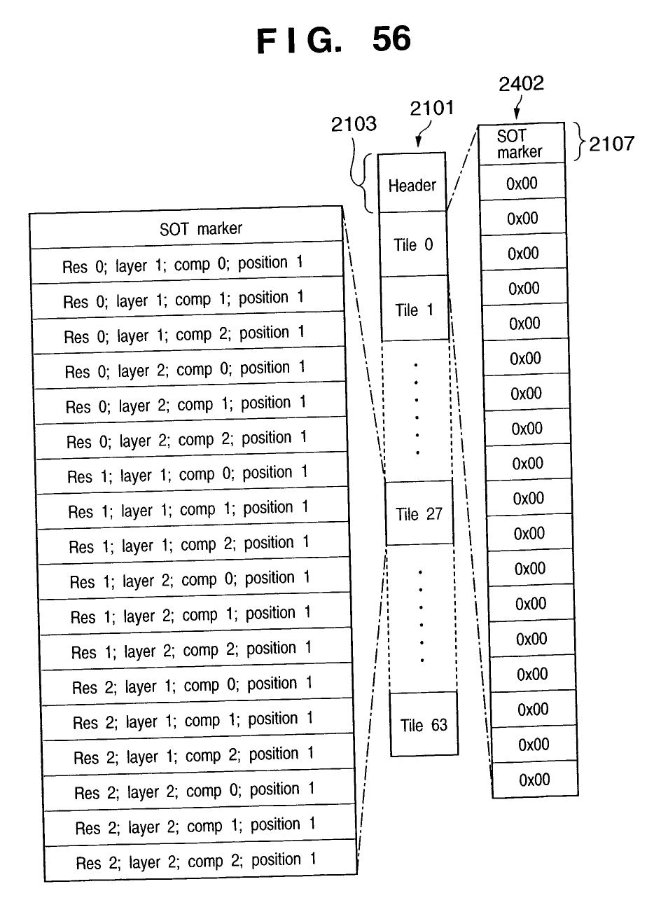

Since it is determined in step S55138 that tile T is not required in display, a 1-byte value “0” indicating a ZLP is written as a dummy value in all packet data fields contained in tile T. For example, if the value of the number of packets Pmax contained per tile is “18”, a 1-byte value “0” is written for 18 bytes after a tile header (SOT marker) 2107, as indicated by 2402 in FIG. 56.

In step S55127, “0” is set in a packet number counter P to reset that counter, and “0” is substituted in a variable Length used to count the data length of packet data required in display in tile T to reset that counter. The flow advances to step S55128 to see if packet P has already been received and cached. If NO in step S55128, the flow advances to step S55129; otherwise, the flow advances to step S55130. For example, as for tile 27, since only packet data 2104 (FIG. 54) of resolution level 0 have been received in step S52113, the flow advances to step S55130 when P=0 to 5, and the flow advances to step S55129 when P=6 to 17. However, since packet data of all components at a maximum resolution and maximum SNR have been received and cached in step S52116, the flow advances to step S55130 in case of 18 packets, i.e., P=0 to 17.

In step S55129, since a process for non-received packet data is to be executed, a ZLP value, i.e., a 1-byte value “0” is written in the display file as data of packet P. If it is determined in step S55128 that packet data is cached, the flow advances to step S55130 to extract data of packet P from the cache, and to directly write it in the display file. The flow advances to step S55131 to add the number of bytes written in the file in step S55129 or S55130 to the variable Length. For example, if the ZLP value is written in step S55129, “1” is added to the variable Length; if the number of bytes of packet P written in the file in step S55130 is 100 bytes, “100” is added to the variable Length. The flow advances to step S55132 to increment the count value of the number of packets P by “1”. It is checked in step S55133 if the value P is equal to Pmax. If YES in step S55133, the flow advances to step S55134; otherwise, the flow returns to step S55128.

For example, in case of a tile which has the number of resolution levels=“3”, the number of layers=“2”, and the number of components=“3”, since this tile contains 18 packets, if the number of packets P is “18”, the flow advances to step S55134. Otherwise, the flow returns to step S55128. In step S55134, the tile length of tile T is re-calculated based on the value of the variable Length, and is overwritten on the value of Psot 1101 (FIG. 11A) indicating the tile length of the SOT marker. For example, if the tile header contains the SOT marker alone, and the value of the variable Length is “286”, a value (14+Length=) “300” is overwritten on this Psot 1101. More specifically, in the data fields for tiles 27, 28, 35, and 36 in the display file generated in step S52113, 18 packet data 2102 (FIG. 54), which are the same as those in the file in the server 204, are written, thus generating a file shown in FIG. 56.

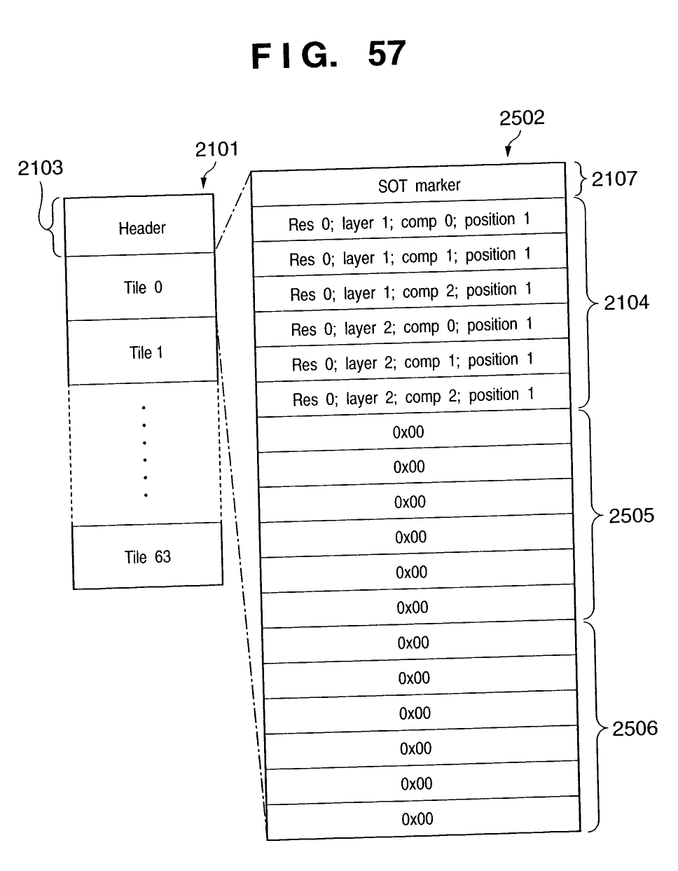

For example, in case of the display file generated in step S52113, since only six packet data, which are required in display and are indicated by 2104 in FIG. 54, have been received for each tile, a file, in which “0”s for 12 bytes are written (2505 and 2506 in FIG. 57) in fields 2105 and 2106 in FIG. 54 after packet data 2104 received from the server 204 in the data fields of respective tiles in the display file, is generated.

In step S55135, the tile number counter T is incremented by 1. It is checked in step S55136 if all tiles have undergone the above processes. If the count value T is equal to Tmax, i.e., since all tiles have been processed, the flow advances to step S55137; otherwise, the flow returns to step S55125. For example, when the number of tiles is “64”, if the value of the counter T is “64” the flow advances to step S55137; if the value of the counter T is not equal to “64”, the flow returns to step S55125. In step S55137, a 2-byte value “0xFFD9” as an EOC code of JPEG2000 is written, thus closing the file.

Since such encoded data generation process is adopted, a file in which only packet data of tiles required in display are written, and ZLP values are written as data of other tiles can be easily generated by checking if a given tile is required in display. In addition, using ZLP values as non-received data of a required tile, a JPEG2000 compatible encoded data file can be easily generated.

<13th Embodiment>

In the 12th embodiment, it is checked for each tile if data are required in display, and if they are required, all data received for that tile are written in a display file, and ZLP data are written as dummy data for non-received packets in that tile. In other words, ZLP data are written as tile data which are not required in display. That is, since all received data are written in association with a tile to be displayed, packet data which are not required upon display may be included. Therefore, the 12th embodiment is not satisfactory to generate a file according to the user's display request.

For example, when a map of the whole Kawasaki city is displayed, a detailed place around a target place (e.g., address “Nakahara-ku Imaikami-machi 53”) is recognized by displaying an image with the highest resolution, and the positional relationship between “Musashikosugi Station” and the target place is recognized by zooming out the image, packet data which are not required in display are included in the method according to the 12th embodiment. Hence, in order to generate an encoded data file closely related to the display request, data must be selected for respective packets in a tile required in display in addition to selection of data for respective tiles.

[Method of Determining Write Data for Each Packet]

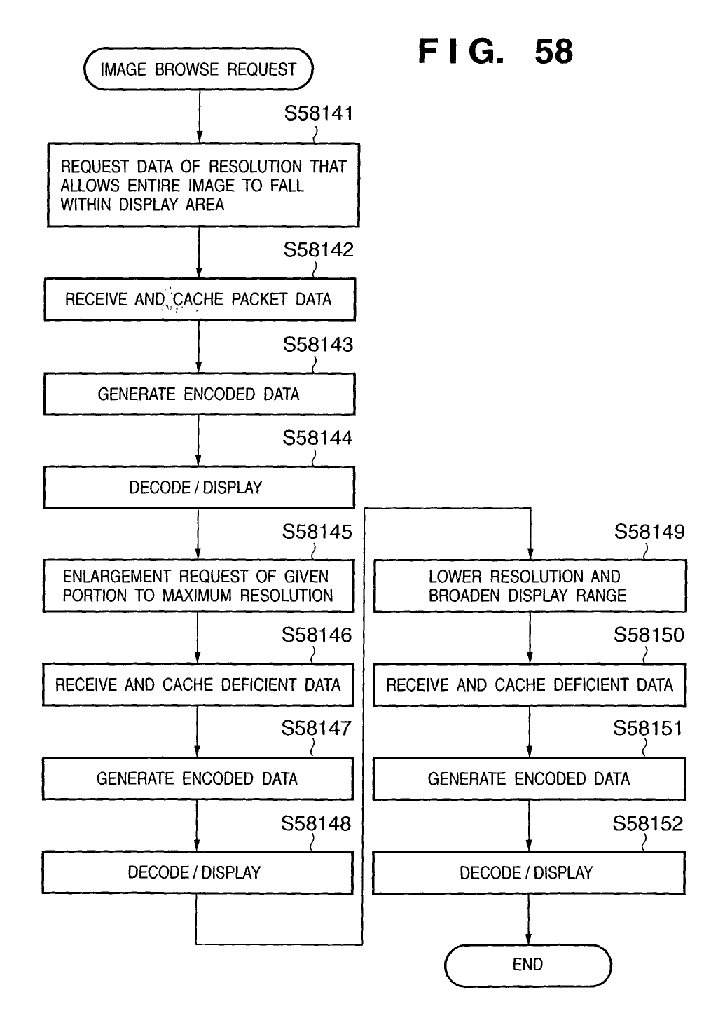

The aforementioned operations for enlarging a portion of an image to a maximum resolution and then broadening the display range by lowering the resolution are shown in steps S58149 to S58152 in FIG. 58. Note that the processes in steps S58141 to S58148 in the flow chart in FIG. 58 are the same as those in steps S52111 to S52118 in the flow chart in FIG. 52, and a description thereof will be omitted.

In step S58149, a request for displaying an image with a lower resolution than that of the image displayed in step S58148 so as to broaden the partial region of the image that can fall within the display area is issued. For example, if the region 2001 shown in FIG. 53A is displayed at resolution level 2 on a 256×256 (pixels) display area in step S58148, the request is issued to display a region bounded by tiles 18, 21, 42, and 45 at resolution level 1, i.e., to display the region 2002 (FIG. 53B) is issued in step S58149. The flow advances to step S58150, and packet data, which are required in display requested in step S58149 but are not cached, are received and cached. That is, packet data 2105, which are contained in 12 tiles with tile numbers 18 to 21, 26, 29, 34, 37, and 42 to 45 and form resolution level 1, are received and cached. Hence, 2 (layers)×3 (components)×12 (tiles)×1 (resolution)=72 (packets) are received and cached in step S58150. The flow advances to step S58151 to generate encoded data using only packets required in display from the cached data. The flow advances to step S58152 to decode and display the encoded data generated in step S58151. In step S58151, encoded data is generated based on only required packet data from cached data.

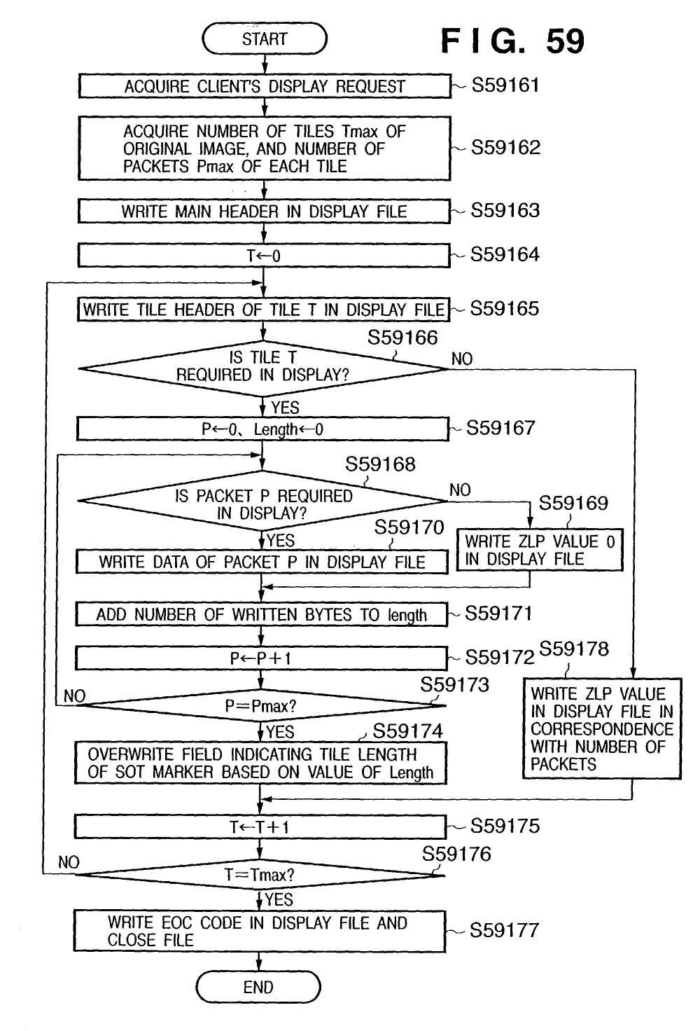

FIG. 59 is a flow chart showing the processing operation upon generating encoded data in step S58151 in FIG. 58. Note that processes in steps S59161 to S59167, and steps S59169 to S59178 in FIG. 59 are the same as those in steps S55121 to S55127 and steps S55129 to S55138 in FIG. 55, and a description thereof will be omitted.

In step S59161, the resolution level, layer, and component are acquired in addition to the tile number as the client's display request. In the 12th embodiment described above, whether or not data is written in a file is determined based only on the tile number. However, in the 13th embodiment, only packet data required in display in a tile required in display are written in a display file. For this purpose, detailed display conditions such as the resolution level, layer, and component are required. After the processes in step S59162 and subsequent steps, since the process in step S59168 is different from that in the 12th embodiment, and the operations in the remaining steps are the same as those in the 12th embodiment, a description thereof will be omitted.

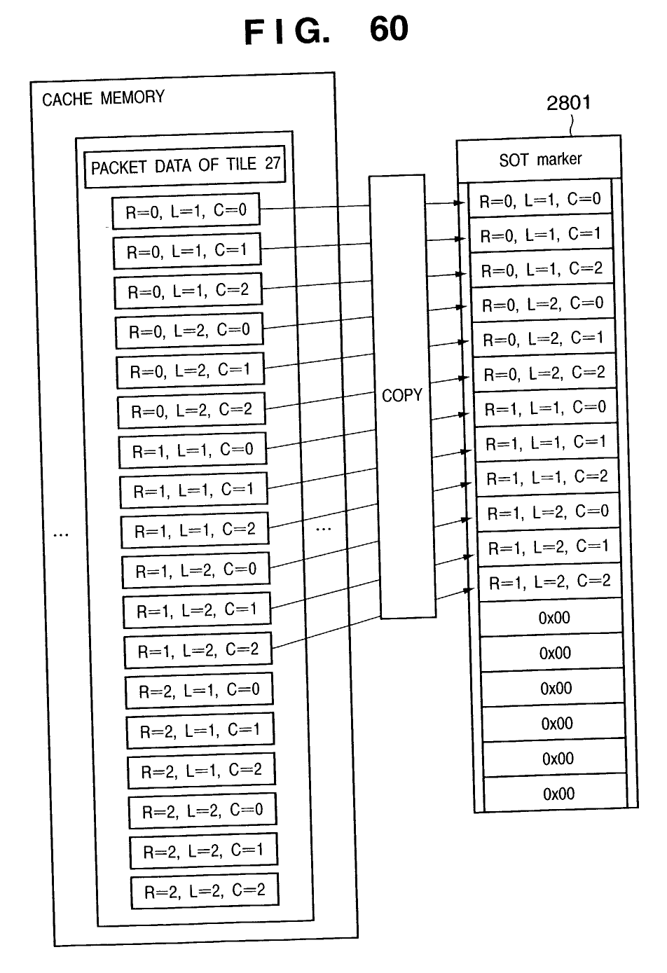

It is checked in step S59168 for packets contained in a tile required in display if packet P is required to form the requested display window. If that packet data is required, the flow advances to step S59170; if that packet data is not required, the flow advances to step S59169. For example, since only packets that form resolution levels 0 and 1 of tile 18 are cached in step S58150 in FIG. 58, all the cached packet data are written in the display file after the flow advances to step S59170 via step S59168 in case of tile 18. However, not all cached data of tile 27 are used upon generating the display window. That is, it is determined in step S59168 that packet data P=0 to 11, which form resolution level 0 or 1 are required, and the flow advances to step S59170. However, since packet data (P=12 to 17) corresponding to resolution level 2 are included in cached data but are not used in current display, the flow advances to step S59169, and ZLP values, i.e., 1-byte values “0” are written in the file in place of these cached packet data. Hence, data 2801 shown in FIG. 60 are written in the display file in association with tiles 27, 28, 35, and 36.

FIG. 60 is a view for explaining the process for generating display data 2801 from cached packet data of tile 27.

In this case, packet data of tile 27, which correspond to resolution levels 0 and 1, layers 1 and 2, and components 0 to 2, are cached, and are directly written as a display file 2801. Since data corresponding to resolution level 2 or higher are not used in display, ZLP values are written after the above packets.

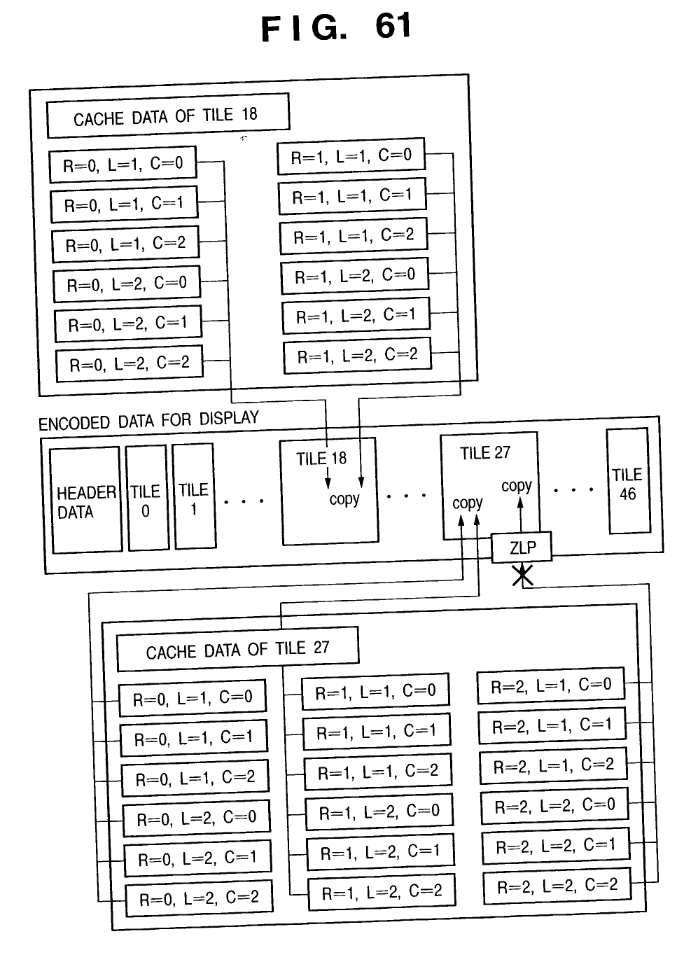

FIG. 61 is a view for explaining a state wherein packet data are written in a display file.

Referring to FIG. 61, as for tile 18, since only packet data that form resolution levels 0 and 1 are cached, all cached packet data are written in the display file in case of this tile 18.

However, as for tile 27, not all cached data are used upon generating a display window. Hence, it is determined that packet data P=0 to 11 that form resolution level 0 or 1 are required, and these packet data are written in the display file. However, since packet data P=12 to 17 corresponding to resolution level 2 are not used in display, ZLP values, i.e., 1-byte values “0” are written in place of the cached packet data.

By adopting such encoded data generation method, a JPEG2000 compatible encoded data file, in which only required packet data of required tiles are written, and ZLP values are written as other packet data, can be easily generated.

In the above description, as for a data cache method, a method of independently managing respective packets, a method of saving packets together in a single file, and other methods may be used as long as each packet data can be read out when it is required.

As described above, using the file generation method according to this embodiment, when tiled data of JPEG2000 encoded data sent using IIP are cached, and JPEG2000 encoded data that a normal JPEG2000 decoder can process is generated from this cache file, a necessary and sufficient display file to which only packets to be currently decoded/displayed of encoded data are copied can be generated.

In this way, the load on the data copy process upon generating an encoded data file can be reduced, and quick file generation can be done.

Upon decoding encoded data to generate a display window, since ZLP data as dummy values are used as packet data which are not required in decoding/display, a display process can be executed without requiring any special decoder.

Furthermore, the decoder need not select/reject received encoded data so as to generate a display window. Also, the size of the JPEG2000 encoded data file to be generated can be reduced. Moreover, the JPEG2000 decoder can attain high-speed processes without processing extra data.

Note that the present invention may be applied to either a system constituted by a plurality of devices (e.g., a host computer, interface device, reader, printer, and the like), or an apparatus consisting of a single equipment (e.g., a copying machine, facsimile apparatus, or the like).

The objects of the present invention are also achieved by supplying a storage medium, which records a program code of a software program that can implement the functions of the above-mentioned embodiments to the system or apparatus, and reading out and executing the program code stored in the storage medium by a computer (or a CPU or MPU) of the system or apparatus.

In this case, the program code itself read out from the storage medium implements the functions of the above-mentioned embodiments, and the storage medium which stores the program code constitutes the present invention.

As the storage medium for supplying the program code, for example, a floppy disk, hard disk, optical disk, magneto-optical disk, CD-ROM, CD-R, magnetic tape, nonvolatile memory card, ROM, and the like may be used.

The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

The aforementioned embodiments of the present invention may be practiced solely or in appropriate combinations.

The present invention is not limited to the above embodiments and various changes and modifications can be made within the spirit and scope of the present invention. Therefore, to apprise the public of the scope of the present invention, the following claims are made.

What is claimed is:

1. An image processing apparatus for receiving and caching encoded data, which are segmented in a predetermined format, of an image that a user wants, from an external apparatus which is connected via a communication network to allow bidirectional communications, comprising:
reception means for receiving header data associated with the image from the external apparatus prior to reception of the encoded data;
calculation means for calculating the number of tiles which form the image, and the number of encoded data required to form each tile on the basis of the header data received by said reception means;
dummy data generation means for setting predetermined dummy encoded data in correspondence with the number of encoded data in each of tiles calculated by said calculation means; and
data replacement means for replacing dummy encoded data, corresponding to the encoded data actually received from the external apparatus, of the dummy encoded data set by said dummy data generation means, by the encoded data received from the external apparatus.

2. The apparatus according to claim 1, further comprising management file generation means for generating a management file of the encoded data on the basis of attribute information contained in the header data prior to the setting process of the dummy encoded data by said dummy data generation means, and
wherein said data replacement means manages the dummy encoded data and the encoded data using the management file on the basis of independent area reference information in a storage medium, and replaces the dummy encoded data by the encoded data actually received from the external apparatus by rewriting the area reference information.

3. The apparatus according to claim 1, wherein the encoded data tiled in the predetermined format are encoded data for respective packets based on JPEG2000.

4. The apparatus according to claim 3, wherein the dummy encoded data are zero length packet data specified by the bit-stream syntax complying with JPEG2000.

5. The apparatus according to claim 4, wherein said dummy data generation means sets the zero length packet data for each packet.

6. The apparatus according to claim 2, wherein the encoded data segmented in the predetermined format are encoded data for respective packets based on JPEG2000, said dummy data generation means forms the zero length packet data using one file in a single cache, and said data replacement means refers to the one file in accordance with a file name of the management file that manages the encoded data for respective packets.

7. The apparatus according to claim 2, wherein the encoded data segmented in the predetermined format are encoded data for respective packets based on JPEG2000, and said dummy data generation means sets NULL as the zero length packet data.

8. The apparatus according to claim 3, wherein said dummy data generation means distributes and stores packets in a plurality of folders in accordance with the number of packets as the number of encoded data.

9. The apparatus according to claim 3, wherein said dummy data generation means generates folders for respective encoded data.

10. The apparatus according to claim 1, further comprising decode means for sequentially reading out a cache file that has been replaced by said data replacement means, and decoding readout data on the basis of a decode sequence complying with the predetermined format.

11. The apparatus according to claim 1, further comprising management file generation means for generating a management file of the encoded data on the basis of attribute information contained in the header data prior to the setting process of the dummy encoded data by said dummy data generation means, and
wherein said data replacement means saves the dummy encoded data and the encoded data in a file where the management file is saved, and replaces the dummy encoded data by the encoded data actually received from the external apparatus by rewriting area reference information in the management file.

12. The apparatus according to claim 11, wherein the encoded data segmented in the predetermined format are encoded data for respective packets based on JPEG2000, said dummy data generation means generates one zero length packet data in a single cache, and said data replacement means refers to the zero length packet data in accordance with offset information that indicates a saving location of the encoded data for each packet.

13. A data cache method for an image processing apparatus for receiving and caching encoded data, which are segmented in a predetermined format, of an image that a user wants, from an external apparatus which is connected via a communication network to allow bidirectional communications, comprising:
a reception step of receiving header data associated with the image from the external apparatus prior to reception of the encoded data;
a calculation step of calculating the number of tiles which form the image, and the number of encoded data required to form each tile on the basis of the received header data;
a dummy data generation step of setting predetermined dummy encoded data in correspondence with the number of encoded data in each of tiles calculated in said calculation step; and
a data replacement step of replacing dummy encoded data, corresponding to the encoded data actually received from the external apparatus, of the dummy encoded data set in said dummy data generation step, by the encoded data received from the external apparatus.

14. The method according to claim 13, further comprising a management file generation step of generating a management file of the encoded data on the basis of attribute information contained in the header data prior to the setting process of the dummy encoded data in said dummy data generation step, and
wherein said data replacement step includes a step of managing the dummy encoded data and the encoded data using the management file on the basis of independent area reference information in a storage medium, and replacing the dummy encoded data by the encoded data actually received from the external apparatus by rewriting the area reference information.

15. The method according to claim 13, wherein the encoded data segmented in the predetermined format are encoded data for respective packets based on JPEG2000.

16. The method according to claim 15, wherein the dummy encoded data are zero length packet data specified by the bit-stream syntax complying with JPEG2000.

17. The method according to claim 16, wherein said dummy data generation step includes a step of setting the zero length packet data for each packet.

18. The method according to claim 14, wherein the encoded data segmented in the predetermined format are encoded data for respective packets based on JPEG2000, said dummy data generation step includes a step of forming the zero length packet data using one file in a single cache, and said data replacement step includes a step of referring to the one file in accordance with a file name of the management file that manages the encoded data for respective packets.

19. The method according to claim 14, wherein the encoded data segmented in the predetermined format are encoded data for respective packets based on JPEG2000, and said dummy data generation step includes a step of setting NULL as the zero length packet data.

20. The method according to claim 15, wherein said dummy data generation step includes a step of distributing and storing packets in a plurality of folders in accordance with the number of packets as the number of encoded data.

21. The method according to claim 15, wherein said dummy data generation step includes a step of generating folders for respective encoded data.

22. The method according to claim 13, further comprising a decode step of sequentially reading out a cache file that has been replaced in said data replacement step, and decoding readout data on the basis of a decode sequence complying with the predetermined format.

23. The method according to claim 13, further comprising a management file generation step of generating a management file of the encoded data on the basis of attribute information contained in the header data prior to the setting process of the dummy encoded data in said dummy data generation step, and
wherein said data replacement step includes a step of saving the dummy encoded data and the encoded data in a file where the management file is saved, and replacing the dummy encoded data by the encoded data actually received from the external apparatus by rewriting area reference information in the management file.

24. The method according to claim 23, wherein the encoded data segmented in the predetermined format are encoded data for respective packets based on JPEG2000, said dummy data generation step includes a step of generating one zero length packet data in a single cache, and
said data replacement step includes a step of referring to the zero length packet data in accordance with offset information that indicates a saving location of the encoded data for each packet.

25. An encoded data generation method comprising:
a storage step of receiving segmented encoded data and storing the received data in a memory;
a acquisition step of acquiring a user's display request;
a determination step of determining a progression order on the basis of the display request acquired in said acquisition step;
a change step of changing header information on the basis of a determination result in said determination step;
a check step of checking, based on the header information changed in said change step, if corresponding encoded data is stored in the memory; and
a step of generating JPEG2000 compatible encoded data by reading out the segmented encoded data, which is determined to be stored in the memory in said check step, converting the readout data to a progression order suitable for the display request, and applying dummy codes to encoded data which are not stored in the memory.

26. The method according to claim 25, wherein the segmented encoded data are JPEG2000 encoded data, which are sent via a network, and the encoded data are sent for respective packets.

27. The method according to claim 25, wherein the dummy codes are zero length packet data specified by JPEG2000.

28. The method according to claim 25, wherein said change step includes a step of changing header information for the entire image.

29. The method according to claim 25, wherein said change step includes a step of changing header information in a tile unit.

30. The method according to claim 25, wherein said determination step includes a step of determining the progression order on the basis of the number of resolution levels and the number of layers of the encoded data and the number of resolution levels and the number of layers of the display request.

31. A JPEG2000 encoded data generation method comprising:
a storage step of receiving tiled encoded data and storing the received data in a memory;
an acquisition step of acquiring a user's display request;
a specifying step of specifying encoded data which are minimally required in display on the basis of the display request acquired in said acquisition step; and
a generation step of generating encoded data having the minimum required encoded data by reading out the encoded data specified in said specifying step from the memory, and replacing other encoded data by dummy codes.

32. The method according to claim 31, wherein the segmented encoded data are JPEG2000 encoded data, which are sent via a network, and are sent for respective packets.

33. The method according to claim 32, wherein the dummy codes are zero length packet data specified by JPEG2000.

34. The method according to claim 31, wherein a unit of the minimum required encoded data is a tile.

35. The method according to claim 31, wherein a unit of the minimum required encoded data is a packet.

36. The method according to claim 31, wherein said specifying step includes a step of specifying encoded data on the basis of the display request irrespective of whether or not encoded data are stored in the memory.

37. An encoded data generation apparatus comprising:
storage means for receiving and storing segmented encoded data;
acquisition means for acquiring a user's display request;
determination means for determining a progression order on the basis of the display request acquired by said acquisition means;
change means for changing header information on the basis of a determination result of said determination means;
check means for checking, based on the header information changed by said change means, if corresponding encoded data is stored in said storage means; and
means for generating JPEG2000 compatible encoded data by reading out the segmented encoded data, which is determined to be stored in said storage means by said check means, converting the readout data to a progression order suitable for the display request, and applying dummy codes to encoded data which are not stored in said storage means.

38. The apparatus according to claim 37, wherein the segmented encoded data are JPEG2000 encoded data, which are sent via a network, and the encoded data are sent for respective packets.

39. The apparatus according to claim 37, wherein the dummy codes are zero length packet data specified by JPEG2000.

40. The apparatus according to claim 37, wherein said change means changes header information for the entire image.

41. The apparatus according to claim 37, wherein said change means changes header information for each tile.

42. The apparatus according to claim 37, wherein said determination means determines the progression order on the basis of the number of resolution levels and the number of layers of the encoded data and the number of resolution levels and the number of layers of the display request.

43. A JPEG2000 encoded data generation apparatus comprising:
storage means for receiving and storing segmented encoded data;
acquisition means for acquiring a user's display request;
specifying means for specifying encoded data which are minimally required in display on the basis of the display request acquired by said acquisition means; and
generation means for generating encoded data having the minimum required encoded data by reading out the encoded data specified by said specifying means from said storage means, and replacing other encoded data by dummy codes.

44. The apparatus according to claim 43, wherein the segmented encoded data are JPEG2000 encoded data, which are sent via a network, and are sent for respective packets.

45. The apparatus according to claim 43, wherein the dummy codes are zero length packet data specified by JPEG2000.

46. The apparatus according to claim 43, wherein a unit of the minimum required encoded data is a tile.

47. The apparatus according to claim 43, wherein a unit of the minimum required encoded data is a packet.

48. The apparatus according to claim 43, wherein said specifying means specifies encoded data on the basis of the display request irrespective of whether or not encoded data are stored in said storage means.
